(19) United States
(12) Patent Application Publication
(10) Pub. No.: US 2017/0140358 A1
(43) Pub. Date: May 18, 2017

(54) Network Bridge for Local Transaction Authorization

(71) Applicants: Andrew Orrock, Dallas, TX (US); David Vielehr, Dallas, TX (US)

(72) Inventors: Andrew Orrock, Dallas, TX (US); David Vielehr, Dallas, TX (US)

(21) Appl. No.: 14/944,319

(22) Filed: Nov. 18, 2015

(51) Int. Cl. G06Q 20/20; G06Q 20/40; G06Q 20/34

(52) U.S. Cl. CPC G06Q 20/204; G06Q 20/342; G06Q 20/409

(57) ABSTRACT

In general, the present invention is directed to an apparatus for locally processing stored value card transactions, the apparatus proximate to a retailer point-of-sale (POS) or host, the apparatus in communication with the POS or host and a stored value card processor and configured to: receive a transaction request; determine if the transaction request should be passed through to the stored value card processor or decided upon locally; if the transaction request should be passed through; communicate such request to the stored value card processor, upon receiving a certain response from stored value card processor, or from the attempted communication with the stored value card processor, locally overriding the response of the stored value card processor or deciding upon the transaction request locally; if the transaction request should not be passed through; locally deciding the transaction request; and communicating a transaction request response back to the POS or host.

### BACKGROUND

Stored value card transactions—such as but not limited to activations, deactivations, redemptions, reloads, and refreshes—typically require a retailer point of sale (POS) terminal, system, or host to communicate with a remote processor or server to obtain authorization for the transaction, and/or to conduct the transaction. However, in certain circumstances, communication with the remote processor may not be possible (for example, during power outages or network outrages), or may not be timely (for example, during peak hours or network overloads).

It is therefore desirable to provide systems and methods to locally authorize and/or conduct stored value card transactions. It is further desirable to provide such systems and methods that may communicate when able with the remote processor to update the processor and any associated data stores with new transaction information. Such systems and methods may enable faster processing of transactions and transaction requests.

Various stored value card systems may present some degree of local authorization that may be utilized in very specific circumstances. However, such systems do not provide the ability to (i) continue to reverse certain transaction types upon timeouts, while also adding a stand-in approval facility for designated transaction types; (ii) offer stand-in capabilities for certain “soft declines” as reported; (iii) implement specific requirements such as providing a unique system trace audit number (STAN) on outbound requests emanating from store-and-forward (SAF) transactions; and/or (iv) obtain visibility to SAF content for operational and management level oversight. Note that generally, a “soft decline” is one in which the stored value card processor may decline the transaction, but the issuing party or processor (that is, the actual authorizer for the product and/or transaction) may not have declined the transaction.

Accordingly, such goals are desirable of a system and method in accordance with some embodiments of the present invention.

### SUMMARY OF THE INVENTION

In accordance with some embodiments of the present invention, aspects may include an apparatus for locally processing stored value card transactions, the apparatus proximate to a retailer point-of-sale (POS) or host, the apparatus in selective communication with the POS or host and a stored value card processor, the apparatus comprising: a POS or host interface enabling the selective communication with the POS or host; a stored value card processor interface, enabling the selective communication with the stored value card processor; and a processing module, enabling selective decision making for certain stored value card transaction requests.

In accordance with some embodiments of the present invention, other aspects may include a method of locally authorizing stored value card transactions, the method conducted amongst a retailer point-of-sale (POS) or host, a bridge processor, and a stored value card processor, the bridge processor being disposed locally with the POS or host, the method comprising: receiving at the bridge processor a transaction request; determining by the bridge processor if the transaction request should be passed through to the stored value card processor, or decided upon locally; upon a determination that the transaction request should be passed through to the stored value card processor; communicating such request from the bridge to the stored value card processor; upon receiving a certain response from stored value card processor, or front the attempted communication with the stored value card processor, locally overriding by the bridge processor the response of the stored value card processor or deciding upon the transaction request locally; upon a determination that the transaction request should not be passed through to the stored value card processor; locally deciding by the bridge processor the transaction request; and communicating by the bridge a transaction request response back to the POS or host.

Other aspects in accordance with some embodiments of the present invention may include an apparatus for locally processing stored value card transactions, the apparatus proximate to a retailer point-of-sale (POS) or host, the apparatus in selective communication with the POS or host and a stored value card processor, the apparatus configured to, receive a transaction request; determine if the transaction request should be passed through to the stored value card processor, or decided upon locally; upon a determination that the transaction request should be passed through to the stored value card processor; communicate such request to the stored value card processor; upon receiving a certain response from stored value card processor, or from the attempted communication with the stored value card processor, locally overriding the response of the stored value card processor or deciding upon the transaction request locally; upon a determination that the transaction request should not be passed through to the stored value card processor; locally deciding by the bridge processor the transaction request; and communicating by the bridge a transaction request response back to the POS or host.

These and other aspects will become apparent from the following description of the invention taken in conjunction with the following drawings, although variations and modifications may be effected without departing from the scope of the novel concepts of the invention.

### DESCRIPTION OF THE FIGURES

The present invention can be more fully understood by reading the following detailed description together with the accompanying drawings, in which like reference indicators are used to designate like elements. The accompanying figures depict certain illustrative embodiments and may aid in understanding the following detailed description. Before any embodiment of the invention is explained in detail, it is to be understood that the invention is not limited in its application to the details of construction and the arrangements of components set forth in the following description or illustrated in the drawings. The embodiments depicted are to be understood as exemplary and in no way limiting of the overall scope of the invention. Also, it is to be understood that the phraseology and terminology used herein is for the purpose of description and should not be regarded as limiting. The detailed description will make reference to the following figures, in which:

FIG. 1 illustrates an exemplary store-and-forward (SAF) model with limited processing functionality, in accordance with some embodiments of the present invention.

FIG. 2 illustrates an exemplary SAF model with full processing functionality, in accordance with some embodiments of the present invention.

FIG. 3 illustrates an exemplary flow diagram for poles through operations, in accordance with some embodiments of the present invention.

FIG. 4 sets forth an exemplary process for handling a soft decline with stand-in approval and no SAF impact, in accordance with some embodiments of the present invention.

FIG. 5 illustrates an exemplary process for handling a soft decline with stand-in approval and SAF hard decline, in accordance with some embodiments of the present invention.

FIG. 6 illustrates an exemplary process for handling a soft decline with stand-in approval, when the transaction hits the maximum number of retries, in accordance with some embodiments of the present invention.

FIG. 7 depicts an exemplary process for a host timeout with stand-in approval, in accordance with some embodiments of the present invention.

FIG. 8 illustrates an exemplary processor for a host timeout with stand-in approval, in accordance with some embodiments of the present invention.

FIG. 9 depicts an exemplary process for a suspend mode, in accordance with some embodiments of the present invention.

FIG. 10 illustrates an exemplary process for originator-based voids and reversals, in accordance with some embodiments of the present invention.

FIG. 11 illustrates an exemplary process for a pending SAF transaction, in accordance with some embodiments of the present invention.

FIG. 12 illustrates an exemplary process for a complementary item in the SAF, in accordance with some embodiments of the present invention.

FIG. 13 illustrates an exemplary process for handling a product with a universal product code (UPC) that is not within an expected range, in accordance with some embodiments of the present invention.

FIG. 14 illustrates an exemplary process for handling a product with a universal product code that is not active for the SAF system, in accordance with some embodiments of the present invention.

### DETAILED DESCRIPTION

Before any embodiment of the invention is explained in detail, it is to be understood that the present invention is not limited in its application to the details of construction and the arrangements of components set forth in the following description or illustrated in the drawings. The present invention is capable of other embodiments and of being practiced or being carried out in various ways. Also, it is to be understood that the phraseology and terminology used herein is for the purpose of description and should not be regarded as limiting.

The matters exemplified in this description are provided to assist in a comprehensive understanding of various exemplary embodiments disclosed with reference to the accompanying figures. Accordingly, those of ordinary skill in the art will recognize that various changes and modifications of the exemplary embodiments described herein can be made without departing from the spirit and scope of the claimed invention. Descriptions of well-known functions and constructions are omitted for clarity and conciseness. Moreover, as used herein, the singular may be interpreted in the plural, and alternately, any term in the plural may be interpreted to be in the singular.

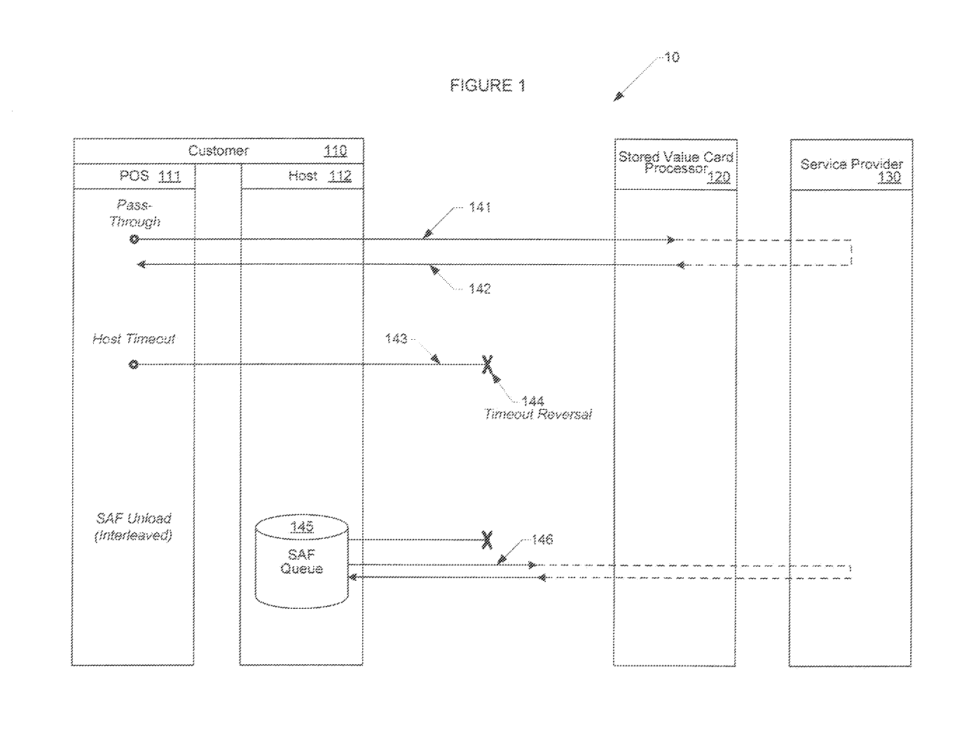

With reference to FIG. 1, under current methodologies, if a financial transaction times out at the retailer's host—for example, while awaiting a response from the stored value card processor—a timeout reversal (TOR) may be generated and provided to a SAF system. Otherwise, the host communicates directly with the stored value card processor for other transactions. With continued reference to FIG. 1 and process 10, a retailer 110 may communicate directly with a stored value card processor 120, which in turn may communicate with a service provider 130.

Service provider 130 may be the party actually issuing or redeeming the stored value card. Stored value card processor 120 may be an intermediate party that may provide services related to a plurality of stored value cards. Retailer 110 may be a typical retailer or merchant with point of sale locations. For example, retailer 110 may be Walgreens, who may offer for sale a plurality of stored value cards. Stored value card processor 120 may be Interactive Communications International, Inc. or InComm, who may provide activation and other services related to a plurality of stored value cards offered by Walgreens. Service provider 130 may be an entity that handles card transactions for the issuer of the card—such as Stored Value Solutions, who may handle card transactions for Bed Bath & Beyond gift cards.

During most transactions, the host may operate merely as a pass-through in which it may convey transaction requests 141 to the stored value card processor 120, and may receive responses 142 from the stored value card processor 120. However, during some circumstances there may be a timeout 143 in the attempted communication between the host and the stored value card processor 120. In such circumstances, the host 110 may generate a timeout reversal 144, which may be provided to a SAF que 145. At a later time, the SAF system may communicate with the stored value card processor 120 to reverse any transaction that may have been improperly or incompletely conducted. It can be seen from FIG. 1 that such SAF systems have quite limited capabilities.

In accordance with some embodiments of the present invention, a bridge may be provided that may, amongst other things, provide for one or more of: (i) implementing stand-in approval at the host level (rather than, or in addition to, at the point-of-sale level); (ii) enable specifically identified transaction types only (for example, only permitting stand-in activations); (iii) enable specifically identified products, or product-transaction type combinations; (iv) automatically enable the bridge to communicate with the SAF system during “soft declines” and/or timeouts; and (v) provide results of bridge/SAF activity to sales associate or technician, for example printed on a receipt or displayed on a POS display.

Such functionality may provide for faster and more efficient processing, since certain transaction may be decided locally, while others may require responses from a stored value card processor. Moreover, during times of non-communication or errors, such a system and method may prevent transactions from piling on to and overloading an inefficient processor, thereby enabling systems to overall run more efficiently and quickly.

In general, the present invention is directed to a bridge disposed between a POS system/host and a stored value card processor. The bridge may provide one or more functions. For example, if communication with the stored value card processor is effective and timely, the bridge may be a pass-through to communicate with the stored value card processor and may assist with the routing of transaction requests. If communication with the stored value card processor is not possible, effective, or timely, the bridge may act as a stand-in processor and may conduct certain transactions. Once proper communication with the stored value card processor resumes, the bridge may update the stored value card processor and any associated data stores with updated information associated with transactions the bridge authorized or conducted as a stand-in.

In accordance with some embodiments of the present invention, the bridge may be positioned intermediate of the POS/host and the stored value card processor. For example, the bridge may be physically located at the POS/host location, in a position to receive and route pass-through transactions, while also having connectivity for necessary stand-in transactions.

Positioning the bridge at the POS/host location provides additional benefits. Since a purpose of the bridge is to provide continuous services for certain stored value card transactions, positioning the bridge at the location of the POS/host ensures that the bridge will be in the same environment as the POS/host. In other words, if the bridge was located remotely from the POS/host, it is foreseeable that the bridge location may be the subject of a power outage or network issues, while the POS/host location may be running as normal. Since one of the goals of the bridge is to provide continuous support for the POS/host, locating the bridge with the POS/host may ensure environmental factors will be the same or similar, and that limited network communications may be required to process stand-in authorizations or transactions.

Systems and methods in accordance with some embodiments of the present invention may utilize on or more solid state drives. Solid state drives may comprise, for example, HP ProLiant DL380P (8 2U, which may, for example, utilize Intel Xeon E5-2609 processors. Solid state drives may be in communication with the POS/host directly, via one or more load balancers, and/or via a multiplexer.

In general, the bridge may implement store-and-forward (SAF) functionality to conduct both stand-in and pass through transactions at a retailer location. In accordance with some embodiments of the present invention, the bridge may provide the ability to (i) continue to reverse certain transaction types upon timeouts, while also adding a stand-in approval facility for designated transaction types; (ii) offer stand-in capabilities for certain “soft declines” as reported; (iii) implement specific requirements such as providing a unique STAN on outbound requests emanating from store-and-forward (SAF) transactions; and/or (iv) obtain visibility to SAF content for operational and management level oversight.

Note that modifications to a retailer system may be desirable, recommended, or required for the bridge to offer full functionality. For example, a retailer may be required to modify the settings of transaction routing to route stored value card transactions to the bridge—rather than directly to the stored value card processor. Similarly, a retailer may modify its system to support new response codes associated with stand-in approvals and stand-in declines. Such response codes may be useful in tracking and correlating SAF events and bridge decision making. Also, retailers may provide additional point-of-sale guidance to customers in certain circumstances. For example, if a purchased product receives a stand-in approval, the customer may be informed that the product will be active in twenty-four (24) hours. This information may be conducted orally (from the sales clerk to the customer), or may be printed on the receipt.

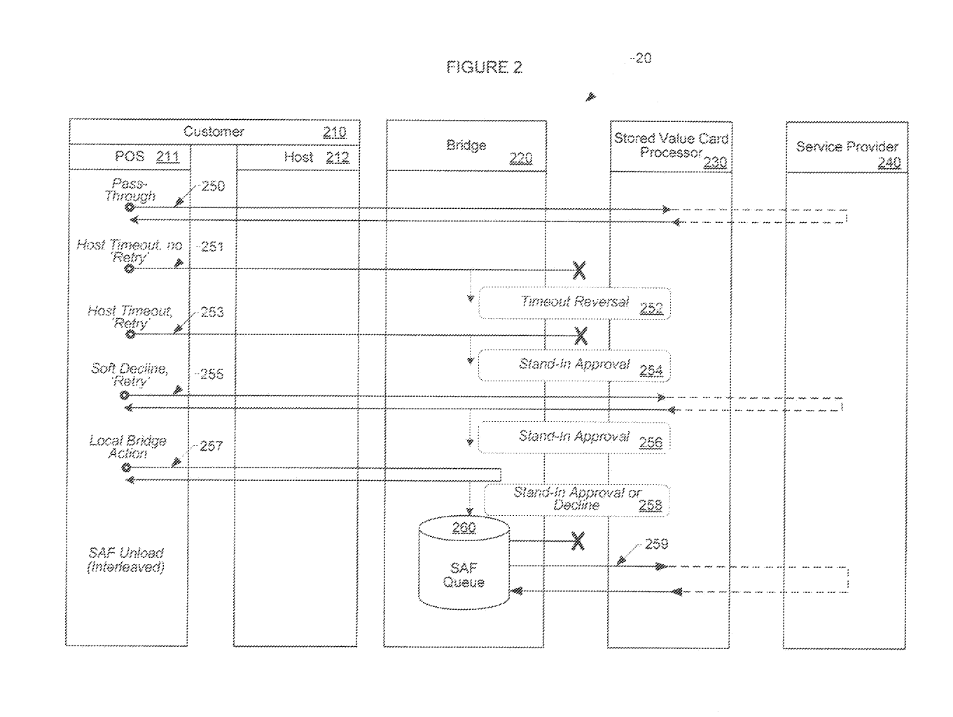

With reference to FIG. 2, an improved SAF model 20 utilizing a bridge, in accordance with some embodiments of the present invention, is depicted. In general, the model 20 illustrates various transactions as conducted amongst a customer 210, which may comprise a POS 211 and/or a host 212. (Note that the use of “customer” here is intended to refer to a merchant or retailer that is a customer of the stored value card processor. For example, a retailer that provides one or more stored value cards or gift cards for sale may be a “customer.”) It is contemplated that similar transactions may be conducted with the POS 211 communicating directly with the bridge 220, although communications through a host 212 may be common. The customer 210 may send communications to the bridge 220, which in turn may either conduct some transactions or may pass-through transaction requests to a stored value card processor 230. Stored value card processor 230 may communicate with service provider 240 to enable or conduct certain transactions.

FIG. 2 sets forth several exemplary transaction types to illustrate the flow through the customer 210, bridge 220, stored value card processor 230, and service provider 240. At 250, a pass-through transaction is illustrated, in which a transaction originates at a POS and is passed through the host 212, passed through the bridge 220, and received at the stored value card processor 230. The stored value card processor may communicate with a service provider 240, although it is also contemplated that the stored value card processor 230 may also be a service provider, or may be authorized to conduct transactions without additional communications. The transaction response is then routed back to the POS 211, through the bridge 220 and the host 212.

At 251, a transaction flow is indicated for circumstances in which the host times out (that is, communication is unable to be effective or timely with the stored value card processor 230), but the specific product type (i.e., the certain stored value card) is not on a “retry” list. In this circumstance, the transaction may originate at the POS 211, pass through the host 212, but may not make it to the stored value card processor 230. Because the product may not be permitted to be transacted by the bridge 220, a time out reversal (TOR) may be issued at 252, which may be stored in the SAF queue 260 for communication with the stored value card processor 230 at a later time.

At 253, a transaction flow is indicated for circumstances in which the host times out, but the specific product type in on the “retry” list. Here, the transaction may originate at the POS 211, flow through the host 212, but may not make it to the stored value card processor 230. However, because the product type is on the “retry” list, the bridge 220 may perform a stand-in approval of the transaction at 254. This stand-in approval may also be stored in the SAF queue 260 for later communication with the stored value card processor 230.

At 255, a transaction flow is indicated for a soft decline for a product type that is on the “retry” list. Again, the transaction originates at the POS 211 and passes through the host 212. The bridge 220 may provide stand-in approval 256 for the transaction, and may again update the SAF queue 260.

At 257 a transaction flow is indicated for transactions that are authorized to be conducted using local bridge action. Here, the transaction may originate at the POS 211, flow through the host 212, and be authorized, approved, or conducted by the bridge 220. Again, the bridge 220 may provide information regarding any stand-in approval or declines to the SAF queue 260 to provide updates to the stored value card processor 230.

Finally, as indicated above, at 259 the SAF system may update the stored value card processor 230 by providing a listing or queue of transactions conducted or declined by the bridge 220.

In order for a customer 210 to properly utilize such SAF system with a bridge, the customer may be advised to modify its system. Such modifications may include, but are not limited to, providing the abilities to (I) validate current SAF queue content on decision making; (ii) discern “soft” declines from “hard” declines; and/or (iii) modify fields on each SAF request attempt.

More specifically, in order to validate current SAF queue content on decision making, SAF decision making may be guided by the specific, current content of the SAF queue. For example, if an activation request is received (or similarly, a reload request is received)—while an activation request for the same stored value card is already present in the SAF queue, the follow-up or subsequent transaction should be locally denied.

With regard to discerning “soft” declines from “hard” declines, a “soft” decline may be a candidate for potential stand-in transactions conducted by the bridge, while a “hard” decline may not be. Fields on each SAF request attempt may be modified to prevent repeated or duplicate uses of the same system trace audit number (STAN). Using the same STAN may trigger the stored value card processor to automatically repeat the same response as before. Accordingly, modifying the STAN for each transaction request—particularly in the case of soft declines—may be advisable.

### Host Integration

It is contemplated that the transaction capabilities of the bridge may be integrated into the host, such that the bridge itself may not be necessary. However, since there are often factors that may prevent or delay such integration, the use of the bridge may provide a convenient manner to obtain local stand-in transaction capabilities, without costly and timely modifications to the host of a customer.

### Configuration

In order to configure the host to communicate with the bridge, several configuration files may be helpful or necessary. For example, the ‘QueryHost’ transaction participant may define and control how the bridge connects to an authorizer, and how the bridge should handle responses or lack of responses. The ‘QueryHost’ participant may be called by both the main transaction manager (which may handle real-time requests) and the SAF transaction manager (which may handle subsequent unloading of items that land in the SAF queue as a result of configuration decisions).

In the example below, and in all exemplary coding or files presented herein, note that the specific arrangement, algorithms, and or presentment of information is exemplary only. Numerous approaches or manners may be utilized to achieve the same, substantially the same, or similar results. Moreover, note that the exemplary coding sets forth InComm as the stored value card processor. It is contemplated that the coding presented may be modified in any number of ways, including replacing references to “incomm” with references to other parties.

The participant ‘QueryHost’ may be defined as follows (note that the value, set forth below are exemplary starting values, and are not intended to be any endorsement of final, production settings:

<participant class=“com.ols.incomm.QueryHost” logger=“Q2”
realm=“QueryHost”>

<property name=“mux” value=“incomm-mux-pool” />
<property name=“saf” value=“incomm-svc-saf” />
<property name=“threshold” value=“3500” />
<property name=“timeout” value=“19000” />
<property name=‘retry-response-codes’ value=“91,92,96” />
<property name=‘retry-transaction-codes’ value=“189090” />
<property name=“suspend-manager” value=“suspend-manager” />
<property name=“saf-on-disconnect” value=“false” />
<property name=“checkpoint” value=“query-host” />

</participant>

Table 1 below describes each of the properties specified in the QueryInCommHost.

| Property | Description/Usage |
|---|---|
| mux | The name of the multiplexer (“mux”) that controls the bridge’s |
| | channel connection(s) to this endpoint. If a mux-pool is configured |
| | for the endpoint, its name is listed instead. |
| | This value may match the name contained in the corresponding |
| | mux component (or mux-pool component) of the bridge for this |
| | endpoint. For example, 22_incomm_mux_pool.xml has as its first |
| | line: |
| | <muxpool class=“org.jpos.q2.iso.MUXPool” logger=“Q2” |
| | name=“incomm-mux-pool”> |
| saf | The name of the related SAF manager |
| | This value may match the name contained in the corresponding |
| | SVCSAF = class SAF component. For example, |
| | 20_incomm_saf.xml may have as its first line; <saf |
| | name=‘inComm-svc-saf’ logger=‘Q2’ realm=‘saf’ |
| | class=‘org.jpos.saf.SVCSAF’> |
| threshold | The amount of time in milliseconds beyond which the transaction |
| | may be internally declined (prior to committing to external |
| | authorization). For example, the threshold listed is 3.5 seconds. |
| | Therefore, if an accumulated timer is greater than 3500 ms at the |
| | point committed to send, the transaction may be declined internally |
| | on the bridge and set the RC equal to ‘D5.’ |
| timeout | The amount of time in milliseconds that Query Host gives to the |
| | remote authorizer to provide a transaction response. If no response |
| | is received within this time period, the transaction is considered to |
| | be a timed out request. |
| retry-response- | The response codes received from the authorizer that may result in |
| codes | the bridge treating the request as unsuccessfully delivered. If the |
| | Processing Code of the request is defined as a “retry” code, then the |
| | request may be deemed SAF-able and the item may be recorded in |
| | the SAF tables. |
| retry-transaction- | The list of Processing Code (that is, ‘PC’, ISO8583 field 3) values |
| codes | that are “SAF-able” upon either: |
| | A timeout of the real-time request; or |
| | A real-time request that receives an RC equal to a value contained |
| | in ‘retry-response-codes’ |
| | For example, if this filed is defined as: value = 189090, then the |
| | bridge may write a row to the ‘safMeta’ and ‘safData’ tables |
| | requesting a retry if either the (a) or (b) situations above are |
| | encountered for one of these transaction codes. |
| | However, for transaction codes not included on this list, the bridge |
| | may write a row to the SAF tables requesting a reversal in the |
| | ‘timeout’ scenario (a); or, passing-through a soft decline of the RC |
| | (back to the transaction originator) in the ‘retry RC’ scenario (b). |
| | Note the following processing exceptions that may exist within PC |
| | 189090 at some bridge installations: |
| | 189090 may represent an activation, but may also represent a |
| | universal swipe reload (“swipe reload”). While the activation is a |
| | SAF-able transaction, the swipe reload may not be. |
| | There may not be any other defined field in 189090 that may allow |
| | the bridge to discern an activation from a swipe reload. Therefore, |
| | for each bridge customer that processes swipe reload transactions, |
| | the customer and the stored value card processor may determine a |
| | signaling method. |
| | Even if 18909is defined as a retry-transaction-code, the bridge may |
| | treat any request identified as a swipe reload as if it were a |
| | transaction code that is not included on this list. |
| suspend-manager | The name of the system component that may control the bridge’s |
| | ‘suspend’ operations for an endpoint. This value may match the |
| | name contained in the corresponding suspend component of the |
| | bridge for this endpoint. For example, 12_suspend_manager.xml |
| | may contain the line: <suspend-manager |
| | class=“com.ols.incomm.SuspendManager” logger=“Q2”> |
| saf-on-disconnect | Value setting that denotes whether or not a customer wishes to |
| | stand-in if all routes to an endpoint are disconnected, a condition |
| | known as a “mux disconnect.” |
| | If set to ‘false’ all transaction requests return decline code ‘D4’ |
| | during mux disconnect. |
| | If set to ‘true’ transaction requests of items not on ‘retry-transaction- |
| | codes’ list return decline ‘D4’ during mux disconnect; those on |
| | ‘retry-transaction-codes’ list return approval code, and item may be |
| | placed in SAF to be sent when mux is later reconnected. |
| checkpoint | A descriptive name for the transaction participant step that may |
| | appear in the transaction profiler in the q2.log entry for the |
| | transaction. This feature may indicate how much time (in |
| | milliseconds) each participant is responsible for in a particular |
| | transaction. |

### SAF Manager Definition

An endpoint on-boarded to the bridge may require a defined and deployed SAF Manager component. Such SAF Manager may be in charge of (i) unloading the SAF queue; (ii) retrying SAF replication; and (iii) synching the SAF. More specifically, a SAF Manager may identify SAF entries that may still need to be delivered to a designated endpoint. If the item is available to send, the SAF manager may place the top relevant entries in a que (SAF.TXN) for handling by the SAF Transaction Manager.

SAF replication may be performed to a peer node as part of an unloading process. If replication fails (for example, the request to the peer times out), the SAF Manager may place the top relevant entries on this list in a queue (RETRY.TXN) for handling by the Retry Transaction Manager.

If a node notices that its peer is down, the node may begin to operate in ‘SOLO” mode—in which it is responsible for delivering SAF entries to both nodes. Subsequently, when the node recognizes that its peer is back up, it must now synch to the peer all actions it undertook on its behalf. If synchronization occurs, the SAF Manager may place the top relevant entries on this list in a queue (SYNC.TXN) for handling by the Sync Transaction Manager.

For example, to integrate an endpoint to the bridge approach, a SAF Manager definition may be:

<saf name=‘bridge-saf’ logger=‘q2’ realm=‘saf’
class=‘org.jpos.saf.SAFManager’>

<property name=“endpoint” value=“INCOMM” />
<property name=“echo-mgr” value=“incomm-echo-mgr” />
<property name=“initial-delay’ value=‘10000’ />
<property name=‘penalty-box-time’ value=‘300000’ />
<property name=‘polling-delay’ value=‘500’ />
<property name=‘max-saf-space-queue-size’ value=‘6’ />
<property name=‘max-retry-space-queue-size’ value=‘6’ />
<property name=‘max-sync-space-queue-size’ value=‘20’/>
<property name=‘max-retransmissions’ value=‘12’ />
<property name=‘expire-after’ value=‘43200’> in seconds
</property>
<property name=“node” value=“1” />
<property name=“peer-node” value=“2” /<

</saf>

Table 2 below describes each of the properties specified in the SAF Manager.

| Property | Description/Usage |
|---|---|
| endpoint | The name of the external authorizer of the transactions. This |
| | value may match the value provided in the similarly named |
| | property in the ‘StoreInSAF’ participant in the corresponding |
| | main transaction manager for the endpoint. This exists |
| | because the SAF table may contain entries for more than one |
| | external authorization interface. |
| echo-mgr | The name of the system component that may control the |
| | bridge’s network level ‘echo’ requests to the endpoint. In |
| | ISO8583, these are the ‘0800’ series messages. |
| | This value may match the name contained in the |
| | corresponding echo component of the bridge for this endpoint. |
| | For example, 15_incomm_echo_mgr.xml may contain the line |
| | <property name=“echo-mgr” value=”incomm-echo-mgr” /> |
| initial-delay | The time in milliseconds that the bridge components may wait |
| | on service startup (or component redeploy) before initiating its |
| | main loop of logic. For example, a value of ‘10000’ (10 |
| | seconds) allows the bridge application to fully and |
| | comfortably start before SAF operations may be initiated. |
| penalty-box-time | The time in milliseconds that the bridge may wait before re- |
| | attempting the sending of an item from SAF if the previous |
| | attempt to send from SAF resulted in a ‘retry’ outcome, |
| | This value may be an important pacing mechanism, since it |
| | may help ensure that the bridge does not exacerbate notable |
| | problems being experienced at an authorizer by piling on |
| | rapid, repeated attempts that have a good chance of failing. |
| polling-delay | The time in milliseconds that the bridge waits after the |
| | conclusion of its main processing loop before again initiating |
| | processing. If, upon polling the list of items the bridge |
| | determines (a) that there is nothing available to send, it waits |
| | this amount of time before polling again; or (b) that there are |
| | one or more available items to send, and it successfully |
| | processes to some type of resolution for all of the items on the |
| | list. In this case, the bridge may conclude its main processing |
| | loop and away this amount of time before polling again. |
| max-saf-space-queue- | The maximum number of SAF entries that SAF Manager can |
| size | place into the SAF queue (“SAF.TXN”) for delivery to the |
| | endpoint. |
| | Similar to ‘inter-message-delay’ this property may be part of |
| | the bridge’s pacing mechanism. Note that there may be a |
| | temptation to put a large number here and unload the SAF |
| | queue as quickly as possible. However, this may end up |
| | exacerbating original issues by placing undue strain on the |
| | authorizer. |
| | A too-conservative value of ‘1’ may also raise concerns. If the |
| | item at the top of the queue cannot be serviced by the |
| | authorizer due to some reason unique to the item, all other |
| | pending items would be blocked. |
| | A modest setting - such as ‘6’ may provide a balance. |
| max-retry-space-queue- | The maximum number of SAF entries that SAF Manager can |
| size | place into the retry queue (‘RETRY.TXN’) for delivery to the |
| | peer node. |
| max-sync-space-queue- | The maximum number of SAF entries that SAF Manager can |
| size | place into the sync queue (‘SYNC.TXN’) for delivery to the |
| | peer node. |
| max-retransmissions | The maximum number of times the bridge may attempt to |
| | unload a specific item from the SAF queue. The bridge may |
| | tally retransmission tries in the ‘attempts’ column of a ‘safMeta’ |
| | table. If this threshold is reached, the bridge may mark the |
| | request as ‘MAX’ in the status column, thus removing the item |
| | from future consideration. |
| expire-after | The time, in seconds, as measured from the timestamp |
| | recorded in ‘safMeta.created’, after which the bridge will no |
| | longer attempt to sned a specific item from the SAF table. If |
| | this threshold is reached, the bridge may mark the request as |
| | ‘EXP’ in the status column, thus removing the item from future |
| | consideration. |
| node | The node definition of the server processing the SAF request. |
| | When a SAF entry is processed by the SAF Manager, this |
| | value may be recorded in the ‘lastNode’ column. In normal |
| | operations, each node may be responsible for unloading its |
| | own SAF content. If a node is in ‘SOLO’ mode, that node may |
| | be responsible for unloading the SAF content of both nodes. |
| peer-node | The node definition of the peer (i.e., the other) server that |
| | makes up the two-server bridge solution. |

### Echo Manager

Systems and methods in accordance with some embodiments of the present invention may also comprise an Echo Manager, which may control the sending and receiving of network-level messages (for example, 08xx series messages) between the bridge and an external authorizer (e.g., a stored value card processor). An echo message may serve at least two purposes: (i) it may keep permanently connected channels alive in times of low volume (many remote hosts may force-rupture a connection after a period of inactivity; and/or (ii) it may prove an external authorizer, and upon receipt of a valid response to an echo request, can serve to take the bridge out of a suspend mode. The echo manager participant may be defined as follows:

<incomm-echo-manager class=“com.ols.incomm.EchoManager”
logger=“Q2” >

<property name=“persist-space”
value=“je:incomm-echo:space/incomm-echo” />
<property name=“suspend-space”
value=“je:suspend:space/suspend” />
<property name=“mux” value=“incomm-mux” />
<property name=“echo-mgr” value=“incomm-echo-mgr” />
<property name=“channel-ready” value=“incomm.ready” />
<property name=“timeout” value=“19000” />
<property name=“echo-interval” value=“120000” />
<property name=“max-timeouts” value=“20” />
<property name=“node” value=“1” />

</incomm-echo-mgr>

Table 3 below describes each of the properties specified in the Echo Manager.

| Property | Description/Usage |
|---|---|
| persistent- | An in-memory storage area used to maintain the current |
| space | status of the echo manager |
| suspend- | An in-memory storage area used to maintain the current |
| space | status of the ‘suspend’ mode. |
| mux | The name of the multiplexer that controls the bridge’s channel |
| | connection(s) to this endpoint. This value should match the |
| | name contained in the corresponding mux component of the |
| | bridge for this endpoint. For example, 20_incomm_mux.xml |
| | has as its first line: <mux class=“org.jpos.q2.iso.QMUX” |
| | logger=“Q2” name=“incomm-echo-mgr”/> |
| channel- | A list of all channels governed by the mux for this endpoint. |
| ready | |
| timeout | The amount of time in milliseconds that QueryHost gives to |
| | the remote authorizer to provide a response to the echo |
| | request. If not response is received within this time period, |
| | the transaction is considered to be a timed-out request. |
| echo- | The amount of time in milliseconds between echo requests. |
| interval | |
| max- | the number of consecutive timeouts (on customer transaction |
| timeouts | requests, not network level requests) that the bridge may |
| | allow before placing the application into ‘suspend’ mode. |
| | Subsequently, the Echo Manager may use receipt of a valid |
| | response to an echo request to take the bridge back out of |
| | ‘suspend’ mode. |
| node | The node definition of the server (i.e., ‘1’ or ‘2’) |

### Bridge Generated Response Codes

If the bridge intercedes in a transaction and takes any action, it may send a Response Code (‘RC’—field 39) back to the customer's application in the response. These ‘RC Slates’ are designed to provide insight as to the bridge's decision making and give guidance to the customer's host as to any next steps that may be taken.

The bridge's approval slate may be in the form of ‘Bx’. A customer's application may treat any response in which RC=‘Bx’ (e.g. B1, B1, etc.) as an approved transaction. Table 4 illustrates some of the B slate approval codes below.

| Code | Meaning | SAF | Reversal |
|---|---|---|---|
| B0 | Stand in approval on decline. The Bridge received an RC from | Y | N |
| | an authorizer that is on the ‘retry-response-codes’ list; the | | |
| | processing code (‘PC’) is on the ‘retry-transaction-codes’ list. | | |
| B1 | Stand in approval on timeout. The bridge timed out awaiting a | Y | N |
| | response from the authorizer; the PC is on the ‘retry-transaction- | | |
| | codes’ list | | |
| B2 | Stand in approval on pending complementary item in SAF. The | Y | N |
| | bridge may identify a pending complementary transaction for | | |
| | the card in SAF while processing a new request for the card. | | |
| | For example, if a deactivation request is received and an | | |
| | activation request is pending in SAF, the current request must | | |
| | be placed into SAF as well to ensure that the authorizer receives | | |
| | the requests in the proper order. | | |
| B3 | Stand in approval on bridge suspension. The bridge is in | Y | N |
| | ‘suspend’ mode due to reaching the ‘consecutive-timeouts’ | | |
| | setting; the PC is on the ‘retry-transactions-codes’ list. | | |
| B4 | Force Approval/Reversal Accepted. The bridge may receive | Y | Y |
| | messages type 0400 (void or other system-generated reversal) | | |
| | from the customer and may ‘accept’ it (i.e., place if directly into | | |
| | its SAD for subsequent delivery). | | |
| | (Note: a processing exception exists that involves any 0400 of | | |
| | a swipe reload received from a customer. Instead of placing | | |
| | these transaction requests directly into SAF, the bridge may | | |
| | take a ‘one shot live’ (i.e., the bridge may attempt immediate | | |
| | delivery). If that first attempt hits a retry condition, then the | | |
| | ‘B4’ force rule may be applied. | | |
| B5 | Duplicate Approval. The bridge may identify a deactivation | N | N |
| | request for a card in SAF while processing a new deactivation | | |
| | request from the customer. | | |
| B6 | Approval on multiplexer disconnect. All lines from the bridge | Y | N |
| | to the authorizer are currently disconnected; the PC is on the | | |
| | ‘retry-transactions-codes’ list. | | |

Note that for codes B0, B1, B2, B3, and B6, the customer's application should instruct the POS system to advise the customer (either verbally or printed on a receipt), that the product will be available for use within twenty-four (24) hours.

The bridge's decline slate may be in the form of ‘Dx’. The customer's application may treat any response in which RC=‘Dx’ as a declined transaction. Table 5 illustrates some of the D slate decline codes below.

| Code | Meaning | SAF | Reversal |
|---|---|---|---|
| D1 | Decline on pending SAF. The bridge identified a pending | N | N |
| | activation request for the card in SAF while processing a new | | |
| | activation request from the customer. | | |
| D2 | Decline on query remote host timeout. The bridge timed out while | Y | Y |
| | awaiting a response from the authorizer; the PC is not on the ‘retry- | | |
| | transaction-codes’ list. | | |
| D3 | Decline on bridge suspension. The bridge was placed into ‘suspend’ | N | N |
| | mode due to reaching the ‘consecutive-timeouts’ setting; the PC is | | |
| | not on the ‘retry-transaction-codes’ list. | | |
| D4 | Decline on multiplexer disconnect. All routes from the bridge to | N | N |
| | the authorizer are disconnected. | | |
| D5 | Decline on bridge threshold error. The bridge was unable to route | N | N |
| | the transaction for external authorization prior to reaching the | | |
| | specified threshold period; backup protection was invoked. | | |
| D6 | Decline on UPC less than defined minimum amount. This optional | N | N |
| | code represents a scenario in which an otherwise SAF-able | | |
| | transaction result is not taken due to a request for an amount less | | |
| | than the defined minimum amount for the UPC. | | |
| D7 | Decline on UPC greater than defined maximum. This optional code | N | N |
| | represents a scenario in which an otherwise SAF-able transaction | | |
| | result is not taken due to a request for an amount greater than the | | |
| | defined maximum amount for the UPC | | |
| D8 | Item not active for SAF; Stand In Approval on Soft Decline not | N | N |
| | taken. This optional code represents a scenario in which an | | |
| | otherwise SAF-able transaction result on a soft decline was not | | |
| | taken due to item marked as ‘SAF = N’ on customer supplied file. | | |
| D9 | Item not active for SAF; stand in approval on timeout not taken. | Y | Y |
| | This optional code represents a scenario in which an otherwise | | |
| | SAF-able transaction result on timeout is not taken due to the item | | |
| | being marked as ‘SAF = N’ on customer supplied file. | | |
| DA | Decline on Swipe Reload. This conditional code is used to denote | N | N |
| | that an otherwise SAF-able transaction result was not taken due to | | |
| | swipe reload restrictions. | | |

Note that certain decline text may be provided to a POS display. For example, if decline code D1 is issued, the display may show “Original request accepted.” If D2, D3, D4, D5, D8, D9, or DA are issued, the display may show “Try again momentarily.” If D6 or D7 are issued, the display may show “Amount incorrect for product.”

### Database Table Definitions

The bridge may record results and metric information to a transaction log (“tranlog”) tranlog table. The bridge may be configured to run “heavier,” where it writes a tranlog record for every transaction that it sees, whether it invokes SAF or not; or “lighter,” where it writes a tranlog record only for transactions in which it invokes SAF. The choice is conveyed via the ‘log-safed-only’ property in the CreateTranLog participant of the Main Transaction Manager:

<participant class=“com.ols.jpos.CreateTranLog” logger=“Q2”
realm=“CreateTranLog>

<property name=“queue” value=“MAIN.TXN” />
<property name=“space” value=tspace:default” />
<property name=“server” value=“@server@” />
<property name=“log-safed-only” value=“true” />
<property name=“checkpoint” value-“create-tranlog” />

</participant>

During configuration of the bridge and its characteristics, a heavier configuration may elected (wherein value=‘false’) if the customer wants recorded evidence of the impact of bridge on transaction duration and throughout. Conversely, a customer may opt for a lighter configuration (wherein value=‘true’) if the customer wants to minimize the footprint of the bridge, both in transaction touch and corresponding database maintenance. In general and in accordance with some embodiments of the present invention, a ‘tranlog’ table may be defined as follows:

CREATE TABLE [dbo].[tranlog](

[id] [numeric](19, 0) IDENTITY(1,1) NOT NULL,
[date] [datetime] NULL,
[irc] [varchar](4) NULL,
[rrc] [varchar](4) NULL,
[rc] [varchar](4) NULL,
[duration] [numeric](19, 0) NULL,
[extDuration] [numeric](19, 0) NULL,
[outstanding] [int] NULL,
[node] [varchar](1) NULL,
[pc] varchar′(6) NULL,
[extrc] [varchar](255) NULL,
[peerDuration] [numeric](19, 0) NULL,

PRIMARY KEY CLUSTERED
(
[id] ASC
)WITH (PAD_INDEX = OFF, STATISTICS_NORECOMPUTE =
OFF, IGNORE_DUP_KEY = OFF, ALLOW_ROW_LOCKS = ON,
ALLOW_PAGE_LOCKS = ON) ON
[PRIMARY]
) ON [PRIMARY]
GO

Table 6 below describes each of the properties specified in the tranlog.

| Property | Description/Usage |
|---|---|
| id | The row ID auto = generated by MS SQL Server. |
| date | Timestamp of when the entry was written to SAF table. |
| | [Note: Unlike the ‘safMeta.created’ value, these entries may not be |
| | ‘normalized’ to log at the full second (i.e., milliseconds are not set to ‘000’ but |
| | instead may be recorded with millisecond-level accuracy.) |
| irc | Internal Result Code (‘IRC’) of the bridge. Internal value that may be for |
| | stored value card processor use only. |
| rrc | The Response Code returned by the external authorizer, i.e., the Remote |
| | Response Code (‘RRC’). Note that this value may be returned by the |
| | authorizer on the first, or real-time, request. Subsequent RRCs may be |
| | returned from the authorizer in response to SAF-ed requests are placed into |
| | ‘safMeta.lastRRC’. |
| rc | The response Code (‘RC’) that the bridge may return to the customer’s host in |
| | the real-time response. This value may be the one supplied by the external |
| | authorizer, or - in the situation where the bridge intercedes - one of the |
| | Bridge-generatorRC Slate values. |
| duration | Duration in milliseconds of the transaction from the time it is received by the |
| | bridge, to the time it is recorded on the tranlog. May include all “off-box” |
| | components (see next two values). |
| extDuration | Duration in milliseconds of the transaction from the time it is received by the |
| | bridge, to the time it is waiting for the response during this interval. The |
| | ‘extDuration’ value may be incorporated in the ‘duration’ value. |
| | Note that under certain conditions, the bridge may make a local decision on |
| | the transaction and not involve an external authorizer. In these instances, |
| | extDuration may be recorded as 0. |
| outstanding | The depth of the MAIN.TXN transaction queue when this item was serviced. |
| | In a well-functioning implementation, this value would typically be ‘0’ or |
| | some small number. A larger number may be an indication that more sessions |
| | need to be configured in the main Transaction Manager, or that the external |
| | authorizer is responding to requests very slowly during a peak period. |
| node | The full name of the server that processed the transaction. |
| pc | The Processing Code (‘PC’, ISO8583 Field 3) of the request sent to the |
| | external authorizer. For example, PC values like ‘189090’ (Activation); |
| | ‘199090’ (Reload); ‘289090’ (Deactivation) may be used by a stored value card |
| | processor. |
| extrc | Additional explanatory text on specific non-approval RCs, supplied when |
| | required. |
| peerDuration | Duration in milliseconds of the time the transaction spent at the peer node |
| | replicating SAF content. The bridge may be waiting for the response during |
| | this interval. The ‘peerDuration’ value is incorporated in the ‘duration’ value. |
| | Note that if a transaction is not placed in SAF, the peer Duration is 0 by |
| | definition. No replication may be required. |

In accordance with some embodiments of the present invention, and in order to meet specific requirements of (e.g., altering the STAN on outbound requests emanating from SAF, checking the SAF queue for related entries to direct specific processing), the real-time processing engine of the bridge may writes (and subsequently updates) ‘SAF-able’ items as rows into two interrelated database tables, a safMeta table and a safData table. Each is discussed in turn below.

A safMeta table may contain ‘meta’ data about the SAF entry (e.g., ‘endpoint’) as well as dynamic data related to the entry, i.e., values that the bridge may update after each SAF attempt (e.g., ‘lastSent’. ‘lastStan’). Additionally, any field that the bridge uses as part of a SAF-based database query needs to be located in this ‘Meta’ table.

Similarly, a safData table may contain a secure representation of the SAF request as well as static data related to the entry (e.g., ‘reversal’, ‘inboundStan’)

Writing to a row of these tables may occur in one or more of the following situations: (a) a transaction response is received from an authorizer in which the remote response code (‘RRC’) is listed as one of bridge's retry-response-codes' and the transaction's corresponding transaction code is listed in ‘retry-transaction-codes’; (b) No transaction response was received from an authorizer (i.e., a timeout occurred) and the transaction's corresponding transaction is listed in ‘retry-transaction-codes’; (c) When readying a transaction request, it is observed that all lines to the authorizer were disconnected (a multiplexor disconnect 2 scenario) and the bridge customer configured the system as ‘saf-on-disconnect’ to ‘true’; (d) a request is received from a customer and it is determined that there was a complementary, unsent request for the same card in the SAF table; (e) a transaction response was not received from an authorizer (i.e., a timeout occurred and the transaction's corresponding transaction code is not listed in ‘retry-transaction-codes’ (or is listed but the bridge identified the request as a Swipe Reload); or (f) a terminal-based timeout reversal or customer void/cancellation was received from the point of sale. Note that (a)-(e) may be referred to as ‘host-based timeout reversals.’ and may accordingly be referred to as TORs.

In situations (a)-(d) above, the original transaction may be the item written to the table, while the reversal column in the row may be set to ‘false.’ In situation (e), the reversal of the original transaction may be the item written to the table, and the reversal column in the row may be set to ‘true.’ In situation (f), the reversal of the original transaction may be received directly from the POS and the item may be written to the table, while the reversal column in the row may be set to ‘true.’ In each of the situations, the status of the item when written to the table for the first time by a real-time processing engine may be set to ‘RETRY.’

Subsequently and asynchronously, the bridge's SAF Manager may read this table to determine which row may contain candidates still viable for delivery. A viable candidate may be one in which the item (i) has not expired; (ii) has not reached the maximum number of retry attempts; (iii) was not previously delivered successfully; and/or (iv) did not cause a processing exception during a previous send attempt. Accordingly, the items that remain in a ‘RETRY’ status may be viable candidates for delivery.

In accordance with some embodiments of the present invention, a ‘safMeta’ table may be defined as:

CREATE TABLE [dbo].[safMeta](

[id] [mumeric](19, 0) IDENTITY(1,1) NOT NULL,
[tranId] [numeric] (19, 0) NOT NULL,
[node] [varchar] (1) NOT NULL,
[endpont] [varchar] (20) NOT NULL,
[hash] [varchar] (255) NOT NULL,
[status] [varchar] (5) NOT NULL,
[created] [datetime] NOT NULL,
[pc] [varchar] (6) NOT NULL,
[lastSent] [datetime] NULL,
[lastRRC] [varchar] (2) NULL,
[lastStan] [varchar] (12) NULL,
[lastNode] [varchar] (1) NULL,
[LastAuthId] [varchar] (20) NULL,
[attempts] [int] NULL,
[repStatus] [varchar] (5) NULL,
[repRetryReason] [varchar] (4) NULL,
[repPhase] [varchar] (1) NULL,
[repTime] [datetime] NULL,
[archiveId] [numeric] (19, 0) NOT NULL DEFAULT 0,
[extractId] [numeric] (19, 0) NOT NULL DEFAULT 0,

PRIMARY KEY CLUSTERED
(
[id] ASC
)WITH (PAD_INDEX = OFF, STATISTICS_NORECOMPUTE = OFF,
IGNORE_DUP_KEY = OFF, ALLOW_ROW_LOCKS = ON,
ALLOW_PAGE_LOCKS = ON) ON [PRIMARY]
) ON [PRIMARY
GO
CREATE NONCLUSTERED INDEX [pending] ON [dbo].[safMeta]
(

[hash] ASC,
[status] ASC,
[endpoint] ASC

) WITH (PAD_INDEX = OFF STATISTICS_NORECOMPUTE = OFF,
SORT_IN_TEMPDB = OFF, DROP_EXISTING = OFF, ONLINE =
OFF,
ALLOW_ROW_LOCKS = ON, ALLOW_PAGE_LOCKS = ON) ON
[PRIMARY]
GO
CREATE NONCLUSTERED INDEX [toSend] ON [dbo].[safMeta]
(

[created] ASC,
[status] ASC,
[endpoint] ASC,
[node] ASC

) WITH (PAD_INDEX = OFF, STATISTICS_NORECOMPUTE = OFF,
SORT_IN_TEMPDB = OFF, DROP_EXISTING = OFF, ONLINE =
OFF,
ALLOW_ROW_LOCKS = ON, ALLOW_PAGE_LOCKS = ON) ON
[PRIMARY]
GO
CREATE NONCLUSTERED INDEX [toRetry] ON [dbo].[safMeta]
(

[created] ASC,
[status] ASC,
[endpoint] ASC,
[node] ASC

) WITH (PAD_INDEX = OFF, STATISTICS_NORECOMPUTE = OFF,
SORT_IN_TEMPDB = OFF, DROP_EXISTING = OFF, ONLINE =
OFF,
ALLOW_ROW_LOCKS = ON, ALLOW_PAGE_LOCKS = ON) ON
[PRIMARY]
GO
CREATE NONCLUSTERED INDEX [toUpdate] ON [dbo].[safMeta]
(

[tranId] ASC,
[node] ASC

) WITH (PAD_INDEX = OFF, STATISTICS_NORECOMPUTE = OFF,
SORT_IN_TEMPDB = OFF, DROP_EXISTING = OFF, ONLINE =
OFF,
ALLOW_ROW_LOCKS = ON, ALLOW_PAGE_LOCKS = ON) ON
[PRIMARY]
GO

Table 7 below describes each of the properties specified in the safMeta table.

| Property | Description/Usage |
|---|---|
| id | The row ID may be automatically generated by a MS SQL |
| | server |
| tranid | The ‘id’ value of the related bridge tranlog entry |
| node | The node (‘1’ or ‘2’) which processed the original, related |
| | transaction request and placed the item into SAF |
| endpoint | The endpoint name of the authorizer in the switch |
| | instance. This value may match the one logged to |
| | ‘tranlog.endpoint’ and may be written here as well since |
| | SAF-related tables may contain entries for one or more |
| | external interfaces. |
| hash | An irreversible SHA-512 salted hash of a primary account |
| | number (PAN) of a stored value card product contained in |
| | a transaction request. This value may be important in |
| | order to assist in preventing the sending of real-time |
| | requests for any PAN in which active items (status = |
| | ‘RETRY’ or ‘PEND’) with that same PAN remain in the |
| | SAF tables. Real-time requests that may be blocked due |
| | to this restriction may receive a bridge-generated RC |
| | decline code of ‘D1.’ |
| status | RETRY: Initial state of an entry when written (or updated |
| | when the RC is on the ‘retry’ list |
| | PEND: Entry may be in flight; awaiting response |
| | MAX: Entry reached max retry count |
| | EXP: Entry has reached expiration setting |
| | TAKEN: Entry received a valid RC (or one not specified |
| | on the ‘retry’ list |
| | ISOEX: Entry produced an exception while processing |
| created | Timestamp of when the entry was first written to the SAF |
| | tables. This entry may be normalized to log at the full |
| | second so that the column may be used effectively as an |
| | index component. |
| pc | Processing code (‘PC’ ISO8583 Field 3) of the request sent |
| | to an external authorizer. |
| lastsent | Timestamp of when the entry was last sent to the |
| | authorizer |
| lastRRC | Remote Result Code (‘RRC’, the result code that may be |
| | provided by an external authorizer) taken from the |
| | response to the last retry request. Note that this value may |
| | set to NULL if the last retry request did not receive a |
| | response within an allotted timeout period. |
| lastStan | The System Trace Audi Number (STAN) inserted by the |
| | bridge into ISO8583 Field 11 in the last transaction retry |
| | attempt. Note that in accordance with some embodiments |
| | of the present invention - and in certain circumstances - |
| | the STAN should be altered on a retry to prevent the risk |
| | of getting repeated soft declines. |
| lastNode | The node from which the last SAF attempt was sent. In |
| | ‘NORMAL’ operations, each node may be responsible for |
| | unloading its own SAF content. In ‘SOLO’ mode, a node |
| | may be responsible for unloading both nodes' SAF content |
| lastAuthId | Authorization ID (field 38) received from the stored value |
| | card processor or external authorizer in the last transaction |
| | response. |
| attempts | The number of retries to date for an entry |
| repStatus | The status of the replication attempt (to the peer node). |
| | This value may be only relevant on the originating node. |
| | RETRY: The initial state of the entry when written to the |
| | table; the entry may stay in this state if a replication |
| | attempt hits the ‘SOLO’, ‘DISC’, or ‘TOUT’ situations. |
| | PEND: The replication attempt is in flight and is awaiting |
| | response |
| | SENT: the bridge successfully replicated the SAF entry to |
| | the peer node |
| | FAIL: the replication effort failed and will not be retried |
| repRetryReason | If repStatus = ‘RETRY’, this column denotes why. This |
| | field may also contain failure reasons if repStatus = ‘FAIL’. |
| | This value is only relevant on the originating node. |
| | SOLO: the node was running in ‘SOLO’ mode when it |
| | originated or updated the SAF |
| | DISC: the node was not connected to its peer when it |
| | originated or updated the SAF |
| | TOUT: the node timed out its peer while awaiting a |
| | response to a replication request |
| | NOTF: the node attempted to update an entry on its peer, |
| | but the peer reported it could not find the entry. This may |
| | be used in conjunction with repStatus = ‘FAIL’ |
| repPhase | The phase of the replication attempt to the peer node. |
| | Value is only relevant on the originating node. |
| | O: Original - the node has replicated (or is attempting to |
| | replicate) the original instance of the SAF entry, e.g., |
| | when the bridge makes its first decision on the transaction. |
| | U: Update - the node has replicated (or is attempting to |
| | replicate) the original instance, e.g., when it has received |
| | an approval from the authorizer on a SAF-ed request |
| repTime | Timestamp of when the bridge last initiated a replication |
| | attempt for the entry. |
| archiveId | ID of the archive job run that wrote this record to an |
| | archive file |
| extractId | ID of the extract job run that decided whether to emit this |
| | record to the exception file. The extract job may mark any |
| | completed record that is an exception (i.e., where the |
| | state is ‘EXP’, ‘MAX’, or ‘ISOEX’; or the status is |
| | ‘TAKEN’ and the lastRRC is not ‘00’ as +reconId (e.g., |
| | 156). The extract job may mark any completed that is not |
| | an exception (i.e., status is ‘TAKEN’ and the lastRRC is |
| | ‘00’ as −reconId (e.g., −156). The extract job may not mark |
| | any incomplete record (i.e., status is ‘RETRY’ or ‘PEND’). |

As discussed above, an safData table may also be defined.

CREATE TABLE [dbo].[safData](

[id] [numeric] (19, 0) NOT NULL,
[secureData] [varbinary] (8000) NULL,
[keyId] [varchar] (7) NULL,
[reversal] [tinyint] NULL,
[inboundStan] [varchar] (12) NULL,
[rrn] [varchar] (12) NULL,
[amount] [numeric] (14, 2) NULL,

PRIMARY KEY CLUSTERED
(
[id] ASC
) WITH (PAD_INDEX = OFF, STATISTICS_NORECOMPUTE = OFF,
IGNORE_DUP_KEY = OFF, ALLOW_ROW_LOCKS = ON,
ALLOW_PAGE_LOCKS = ON) ON [PRIMARY]
) ON [PRIMARY]
GO

Table 7 below describes each of the properties specified in the safMeta table.

| Property | Description/Usage |
|---|---|
| Id | The row ID that may be automatically generated by a MS |
| | SQL server for the ‘safMeta’ may be propgated here |
| secureData | An encrypted version of the complete SAF-ed request to be |
| | sent to the authorizer. The bridge may encrypt the data, for |
| | example using a PA-DSS-certified methodology that may |
| | feature a triple DES Derived Unique Key per Transaction |
| | (‘DUKPT’) approach |
| keyId | The identifier of the base derivation key (‘BDK’) used to |
| | encrypt contents of the secureData column using the |
| | bridge's encryption methodology. |
| reversal | A flag indicating whether the item is an original transaction |
| | request attempt to be retried (set to ‘FALSE’) or a reversal |
| | of the original attempt (set to ‘TRUE’) |
| inboundStan | The STAN received by the bridge in ISO8583 field 11 on |
| | the originating, inbound request. The STAN may be |
| | recorded here to provide reporting that may allow all |
| | parties to reconcile transactions |
| RRN | The retrieval reference number (RRN) received by the |
| | bridge in ISO8583 field 37 on the originating, inbound |
| | request. This may also be recorded to facilitate re- |
| | conciliation between all parties |
| amount | The dollar amount of the transaction request. This column |
| | may allow a customer to run SQL queries to tally the dollar |
| | amount of net outstanding transactions at any given time. |

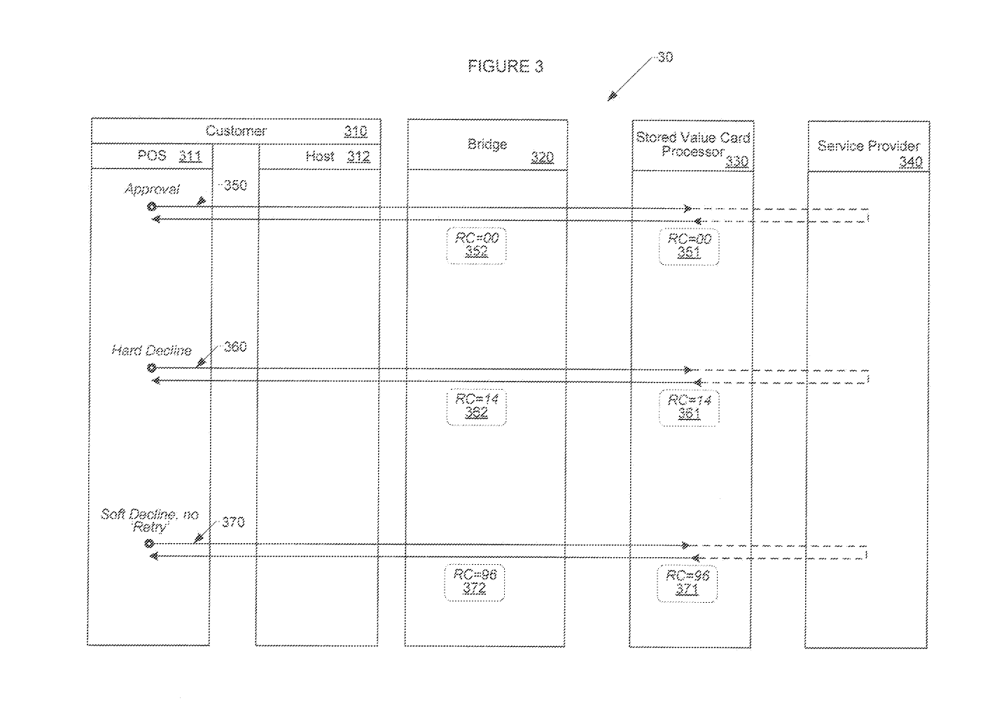

With reference to FIG. 3, exemplary and non-limiting roles and operations of a bridge 30 is illustrated. FIG. 3 depicts various transaction flows, and sets forth the bridge's actions in relation to other transaction actors. Transactions may originate at a customer 310, which may comprise a POS 311 and/or a host 312. The POS 311 may originate a transaction which may flow through the host 312 to the bridge 320. The transaction may continue to flow through the bridge 320 and be delivered to the stored value card processor 330. The stored value card processor 330 may then take care of the transaction (for example, through communication with service provider 340), and may return a transaction response back through the bridge 320, back through the host 312, and to the POS 311. In each of the flows, the bridge 320 may not add value to the transaction other than to faithfully relate the request and the related response.

More specifically, at 350 an approval transaction flow may be seen, where the transaction was approved by the stored value card processor or the ultimate service provider. This transaction flow may originate at the POS 311, flow through the host 312 and the bridge 320 to the stored value card processor 330. The stored value card processor 330 may provide a response code (RC) of 00. The bridge 320 may then convey this RC to the POS 311 via the host 312.

At 360 a hard decline transaction is illustrated. Again, this transaction flow may originate at the POS 311, flow through the host 312 and the bridge 320 to the stored value card processor 330. The stored value card processor 330 may provide a response code (RC) of 14. The bridge 320 may then convey this RC to the POS 311 via the host 312.

At 370 a sot decline, with the processing code not on the ‘retry list’ transaction is illustrated. Again, this transaction flow may originate at the POS 311, flow through the host 312 and the bridge 320 to the stored value card processor 330. The stored value card processor 330 may provide a response code (RC) of 96. The bridge 320 may then convey this RC to the POS 311 via the host 312.

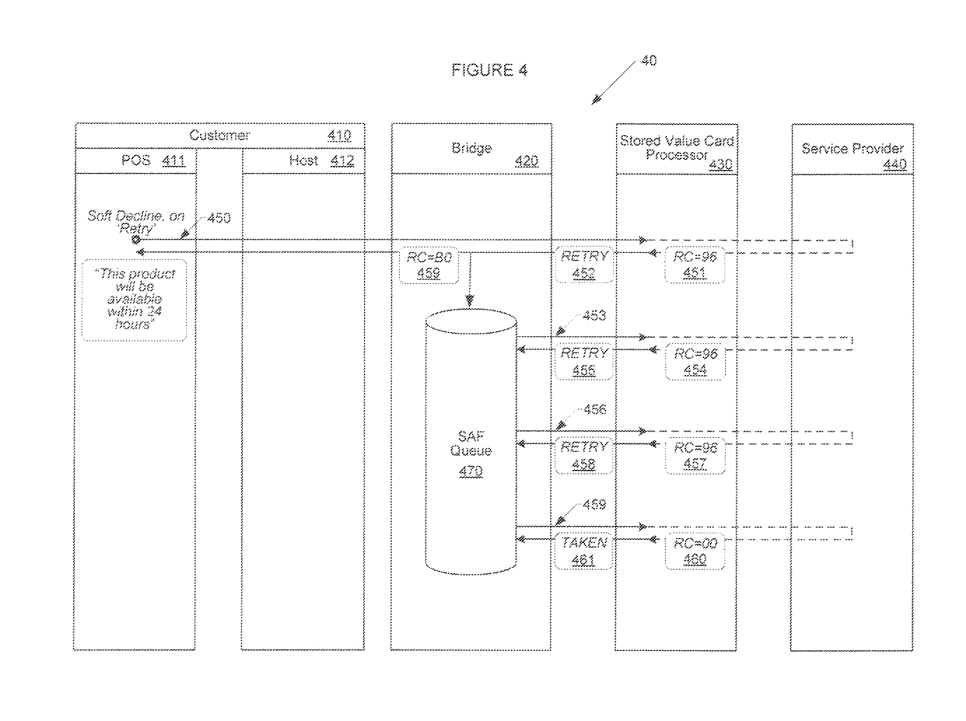

With reference to FIG. 4, an exemplary transaction flow 40 of a soft decline with a stand-in approval (SAF=00) is illustrated. In general, a transaction may be “soft declined” by the stored value card processor, and the transaction is configured on the ‘retry-transaction-code’ list. Accordingly, the bridge may place the item into its SAF queue and changes the RC to the customer to reflect message ‘B0’—stand-in approval on decline. Subsequently, and asynchronously with the transaction, the bridge may send the SAF-ed request of the item to the stored value card processor. The first tries may be declined—with RC of 96. However, because the SAF Transaction Manager may follow the same configuration rules as the main (real-time) transaction manager, each “soft decline” response may result in another attempt—at least up to the configured maximum number of attempts or time allotted. When the transaction succeeds (i.e., it is approved by the authorizer or the stored value card processor), the item may be marked ‘TAKEN’ and may be removed from consideration for future SAF unloading actions.

With continued reference to FIG. 4, the example above is graphically illustrated. A transaction may originate at a customer 410. A customer POS 411 may send a transaction request 450 through its host 412 and to the bridge 420. As before, the bridge 420 may try to send the transaction to the stored value card processor 430. If the bridge 420 receives a soft decline—RC of 96, illustrated at reference numeral 451, the bridge 420 may set the status of the item to ‘RETRY’, set the RC to B0 at 459, and prompt the POS 411 at to note to the purchaser that “This product will be available for use within twenty-four (24) hours.”

The transaction may then be routed to the SAF queue 470 in the bridge 420. At 453 the transaction may be attempted again, though a RC code of 96 is illustrated at 454, noting an additional soft decline. The transaction may be noted as a ‘RETRY’ at 455. At 456 the transaction may be attempted again, and may again receive an RC code of 96 at 457. Again, the transaction may be noted as a ‘RETRY’ at 458. At 459 the transaction may be attempted again, and may be successfully conducted. An RC code of 00 may be returned at 460, after which the transaction may be flagged as ‘TAKEN’ and removed from the SAF queue.

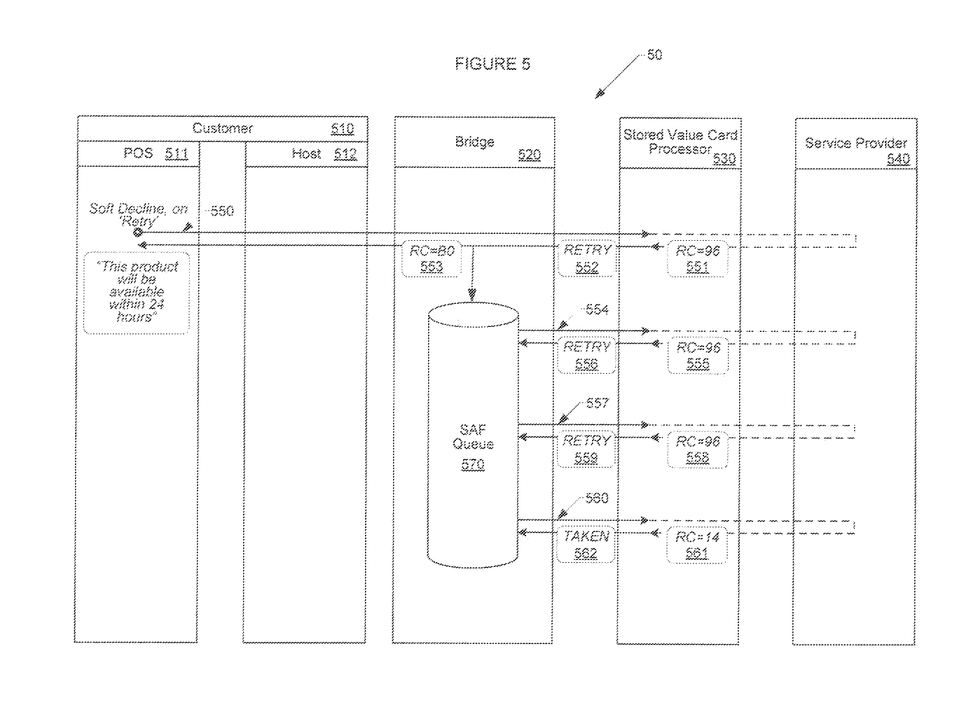

With reference to FIG. 5, an exemplary scenario 50 of a soft decline with stand-in approval and SAF=hard decline is illustrated. In general, a transaction may be soft declined by the stored value card processor or ultimate service provider, and the transaction may again be configured on the ‘retry-transaction-code’ list. Accordingly, the bridge may provide stand-in approval on the decline, and may place the item into the SAF queue, and report an RC code to the POS of B0. Subsequently and potentially asynchronously, the bridge may send the SAF-ed request of the item to the stored value card processor. Two attempts to authorize the item may receive additional soft declines. The third attempt may receive a hard decline from the stored value card processor. This item is then removed from the SAF queue, and should be included in an exception file.

With continued reference to FIG. 5, the example above is graphically illustrated. A transaction may originate at a customer 510. A customer POS 511 may send a transaction request 550 through its host 512 and to the bridge 520. As before, the bridge 520 may try to send the transaction to the stored value card processor 530. If the bridge 520 receives a soft decline—RC of 96, illustrated at reference numeral 551, the bridge 520 may set the status of the item to ‘RETRY’, set the RC to B0 at 559, and prompt the POS 411 at to note to the purchaser that “This product will be available for use within twenty-four (24) hours.”

the transaction may then be routed to the SAF queue 570 in the bridge 520. At the transaction may be attempted again, though a RC code of 96 is illustrated at 555, noting an additional soft decline. The transaction may be noted as a ‘RETRY’ at 556. At 557 the transaction may be attempted again, and may again receive an RC code of 96 at 558. Again, the transaction may be noted as a ‘RETRY’ at 559. At 560 the transaction may be attempted again, and may receive a hard decline RC code of 14, illustrated at reference numeral 561. At 562 the item may be flagged as ‘TAKEN’ and removed from the SAF queue 570. Due to the hard decline from the stored value card processor 530, the item should be included in the exception file.

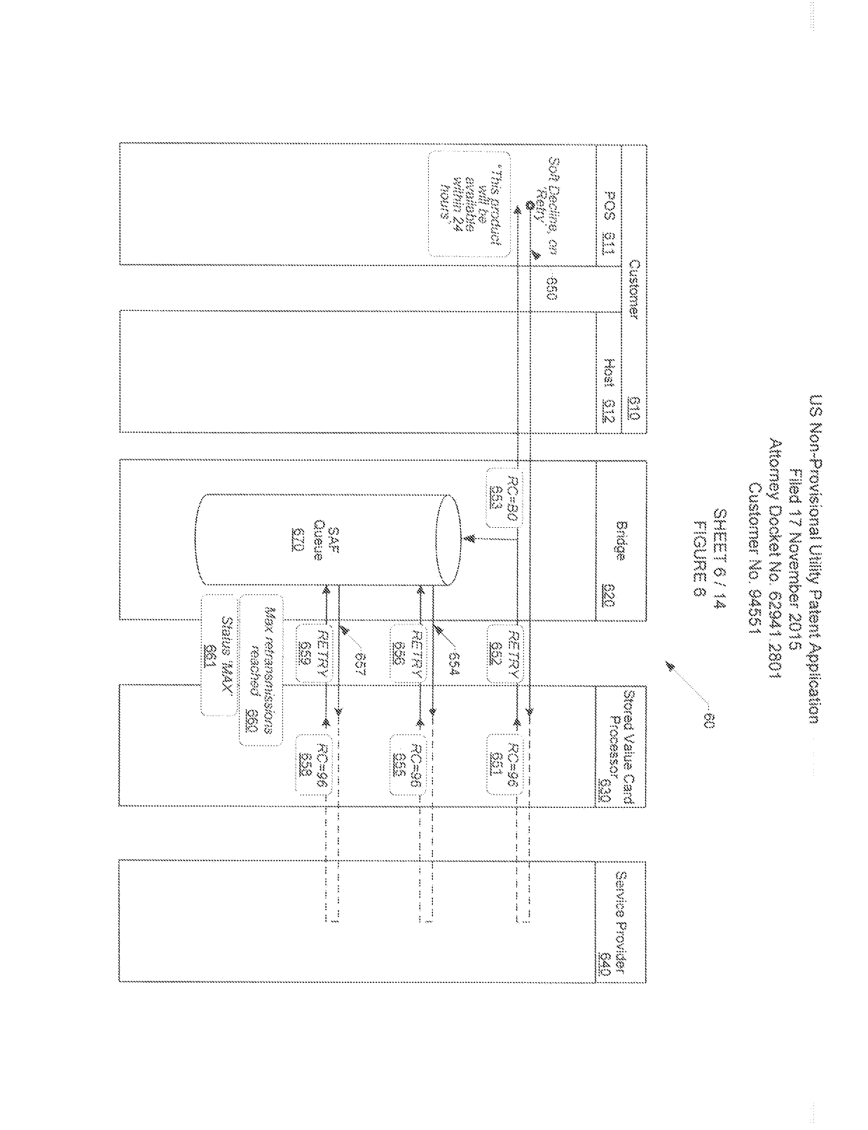

With reference to FIG. 6, an exemplary scenario 60 of a soft decline with bridge stand-in approval, where the SAF hits the maximum number of retries is illustrated. In general, a transaction may be “soft declined” by the stored value card processor or the ultimate service provider, but the transaction may be configured on the ‘retry-transaction-code’ list. The bridge may then place the item into the SAF queue, and may provide stand-in approval, thereby changing the RC to ‘B0’. Subsequently and potentially asynchronously, the bridge may send the SAF-ed request of the item to the stored value card processor. In this example, the bridge may be unsuccessful in obtaining an approval or a hard decline, and instead may reach the maximum number of attempts. Eventually, the SAF manager may recognize that the ‘max-transmissions’ threshold has been met. Before any successful attempt, the SAF manager may mark the item as ‘MAX’ and remove it from consideration for future SAF unloading actions. This item may also be included in the exception file.

With continued reference to FIG. 6, the example above is graphically illustrated. A transaction may originate at a customer 610. A customer POS 611 may send a transaction request 650 through its host 612 and to the bridge 620. As before, the bridge 620 may try to send the transaction to the stored value card processor 630. If the bridge 620 receives a soft decline—RC of 96, illustrated at reference numeral 651, the bridge 620 may set the status of the item to ‘RETRY’ at 652, set the RC to B0 at 653, and prompt the POS 611 at to note to the purchaser that “This product will be available for use within twenty-four (24) hours.”

The transaction may then be routed to the SAF queue 670 in the bridge 620. At 654 the transaction may be attempted again, though a RC code of 96 is illustrated at 655, noting an additional soft decline. The transaction may be noted as a ‘RETRY’ at 656. At 657 the transaction may be attempted again, and may again receive an RC code of 96 at 658. Again, the transaction may be noted as a ‘RETRY’ at 659. At 660 the transaction may reach the maximum number of attempts allowable, and may be flagged ‘MAX’ at 661. At this point the SAF manager may remove the item from the queue. Note that due to the maximum number of attempts being reached without final approval or decline from the stored value card processor 630, the item should be included in the exception file.

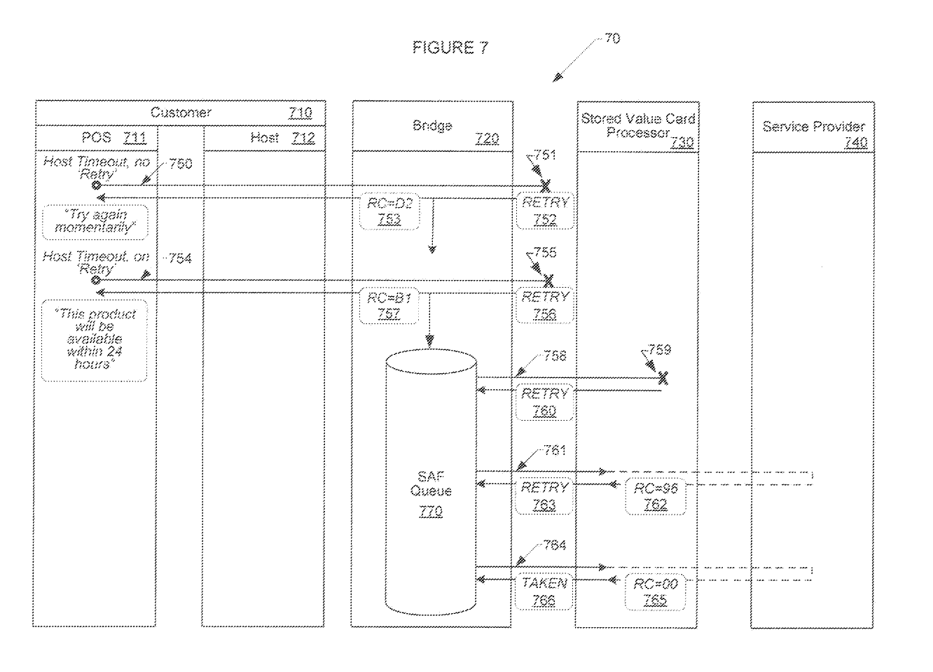

With reference to FIG. 7, an exemplary scenario 70 of a host timeout with stand in approval is illustrated. In general, two-timeout situations are shown to illustrate when action is taken by the bridge. In the first case the processing code is not on the ‘retry’ list; in the second case the processing code is on the ‘retry’ list. The first case, a decline may be received, with RC code of ‘D2’ (decline on query remote host timeout). A reversal request may be created and sent to the SAF to be sent to the stored value card processor. In the second case, the bridge may timeout the request, but may record a stand-in approval where the RC code is ‘B1.’ The SAF-ed request may be sent to the stored value card processor until it is accepted and approved by the stored value card processor—at which point the item may be flagged ‘TAKEN’ and removed from consideration for future SAF unloading actions.

With continued reference to FIG. 7, the example above is graphically illustrated. A transaction may originate at a customer 710. A customer POS 711 may send a transaction request 750 through its host 712 and to the bridge 720. As before, the bridge 720 may try to send the transaction to the stored value card processor 730. If the bridge 720 times out at 751, the status may be set to ‘RETRY’, and the reversal set to ‘TRUE’ at 752. The bridge may then convey an RC of ‘D2’ at 753, informing the POS 711 to “try again momentarily.”

However, at 754 a host timeout may receive a different outcome. Here, a timeout 755 may occur, and the status may again be set to ‘RETRY.’ but the reversal set to ‘FALSE’ at 756. At 757 an RC of B1 may be sent to the POS to inform the purchaser that “this product will be available for use in twenty-four (24) hours.” At 758 the SAF queue 770 may try to conduct the transaction again, and may again time out at 759. At 760 the item may again be flagged as ‘RETRY.” At 761 the bridge may again try to conduct the transaction, and this time may receive a soft decline from the stored value card processor with an RC code of 96 at 762. Again, the item may be flagged as ‘RETRY’ at 763. Finally, at 764 the transaction may be conducted and an RC code of 00 may be returned, indicating that the transaction was successful. At 766 the item may be flagged as ‘TAKEN’ to remove it from the SAF queue 770.

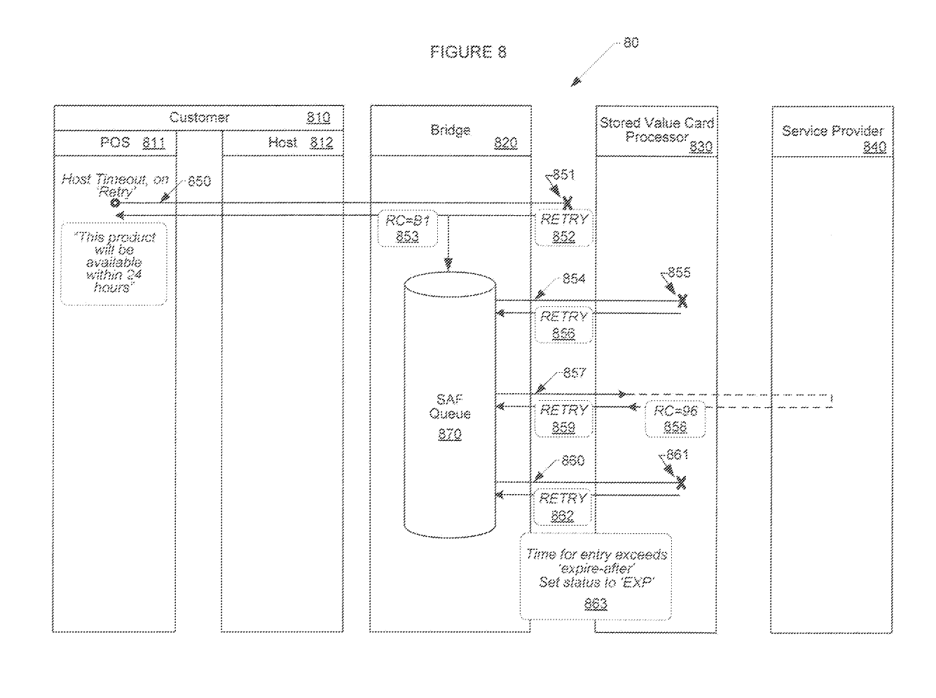

With reference to FIG. 8, an exemplary scenario of a host timeout with stand-in approval by the bridge, where the maximum number of attempts is reached, is illustrated. In general, a transaction request may be sent to the bridge from the POS, and the request may time out. The bridge may then place the item into its SAF queue, provide stand-in approval, and report back to the POS an RC code of ‘B1.’ The bridge may then send the SAF-ed request of the item to the stored value card processor. The first attempt may also time out; the second attempt may receive a soft decline. All subsequent attempts may either timeout or receive a soft decline. Eventually, the SAF manager may recognize that the time period between the SAF entry's creation (‘safMeta.created’) now exceeds the amount of time specified in the ‘expired-after.’ The manager may then mark the item as ‘EXP’ and remove it from consideration for further SAF unloading actions. The item should be included in the exception file.

With continued reference to FIG. 8, the example above is graphically illustrated. A transaction may originate at a customer 810. A customer POS 811 may send a transaction request 850 through its host 812 and to the bridge 820. As before, the bridge 820 may try to send the transaction to the stored value card processor 830. If the bridge 820 times out as illustrated at reference numeral 851, the bridge 820 may set the status of the item to ‘RETRY’, reversal=‘FALSE’ at 852, set the RC to B1 at 853, and prompt the POS 811 at to note to the purchaser that “This product will be available for use within twenty-four (24) hours.”

The transaction may then be routed to the SAF queue 870 in the bridge 820. At 854 the transaction may be attempted again, though again it may timeout at 855. The item may be flagged ‘RETRY’ at 856. At 857 the transaction may be attempted again, and may receive an RC code of 96 at 858. Again, the transaction may be noted as a ‘RETRY’ at 859. At 860 the transaction may again timeout at 861. The transaction may again be flagged as a ‘RETRY’ at 862. However, the time for entry may be recognized to exceed the ‘expire-after’ amount, and at 863 the item may be set to status of ‘EXP.” At this point the SAF manager may remove the item from the queue. Note that due to the maximum amount of time being reached without final approval or decline from the stored value card processor 830, the item should be included in the exception file.

With reference to FIG. 8, an exemplary scenario of a suspend mode 80 is illustrated. In general, FIG. 8 illustrates a suspend mode when the processing code is on the ‘RETRY’ list, and when it is not. When the processing code is not on the ‘retry’ list, the bridge may time out a request, and place the item into the SAF queue, provide stand-in approval, and change the RC reported to the customer to ‘B1.’ The bridge may time out a number of times—exceeding the ‘max-timeouts’ value specified in the Echo manager, which may place the bridge into ‘suspend’ mode.

While in suspend mode, the bridge may decide on transactions locally without querying any external authorizer. If specified on the ‘retry-transaction-code.’ the bridge may place items into the SAF queue and change the response code before returning the transaction to the POS. The response code may be changed to ‘B3’ (stand-in approval on bridge suspension) or ‘D3’ (decline on bridge suspension). Note that the bridge will not attempt to unload SAF entries until the suspend mode is changed. If the stored value card processor responds to an “echo” request, the bridge will exit suspend mode, resume querying the stored value card processor for transaction requests, and unload the SAF queue via the SAF manager.

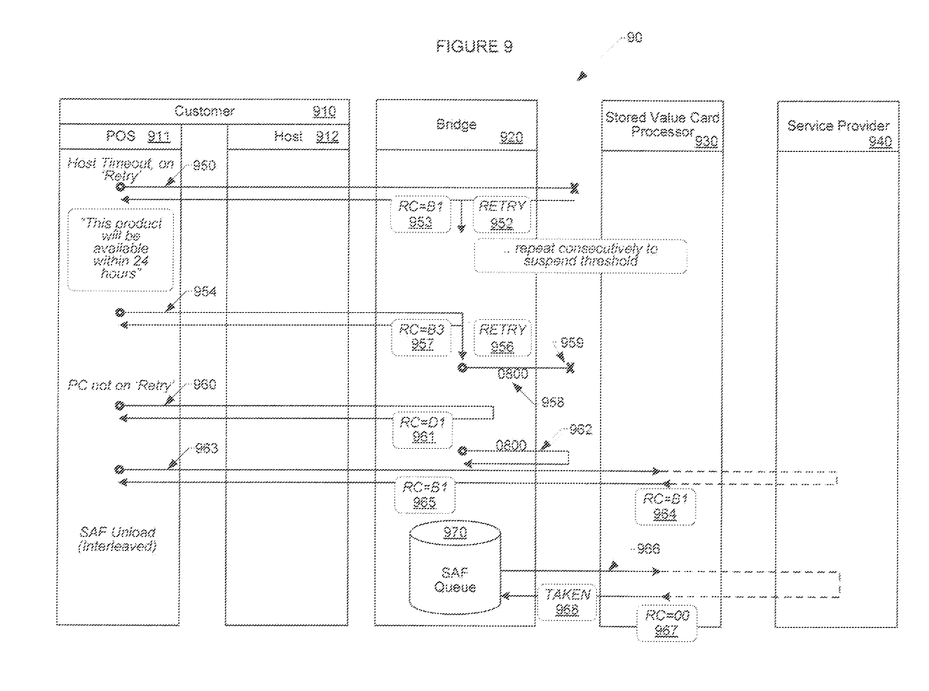

With continued reference to FIG. 9, the example above is graphically illustrated. A transaction may originate at a customer 910. A customer POS 911 may send a transaction request 950 through its host 912 and to the bridge 920. As before, the bridge 920 may try to send the transaction to the stored value card processor 930. If the bridge 920 times out as illustrated at reference numeral 951, the bridge 920 may set the status of the item to ‘RETRY’, reversal=‘FALSE’ at 859, set the RC to B1 at 953, and prompt the POS 911 at to note to the purchaser that “This product will be available for use within twenty-four (24) hours.” The transaction will retry until the maximum number of timeouts is reached at 955 and the bridge enters suspend mode.

During suspend mode, the bridge 920 may receive transaction requests 954 from the POS 911. The bridge 920 may locally authorize the transactions, setting the status to ‘RETRY’ at 956, and returning a response code of ‘B3’ at 957. Moreover, the bride 920 will continue to send echo requests 958 to the stored value card processor 930, though the echo may timeout at 959.

If the processing code is not on the ‘retry’ list, a transaction 960 may be declined by the bridge and RC code of ‘D3’ (decline on bridge suspension) may be issued. At some point, an echo 962 may be returned by the stored value card processor. The bridge 920 will remove itself from suspend mode, and subsequent transactions—such as 963 will be passed through to the stored value card processor 930, and may receive successful messages with RC of ‘00’ at 964, which the bridge 920 may pass on the to the POS 911 at 965. Subsequently, the SAF queue 970 may be unloaded at 966, receiving RC codes of ‘00’ at 967 and flagging the item as ‘TAKEN’ at 968, thereby removing the item from the SAF queue.

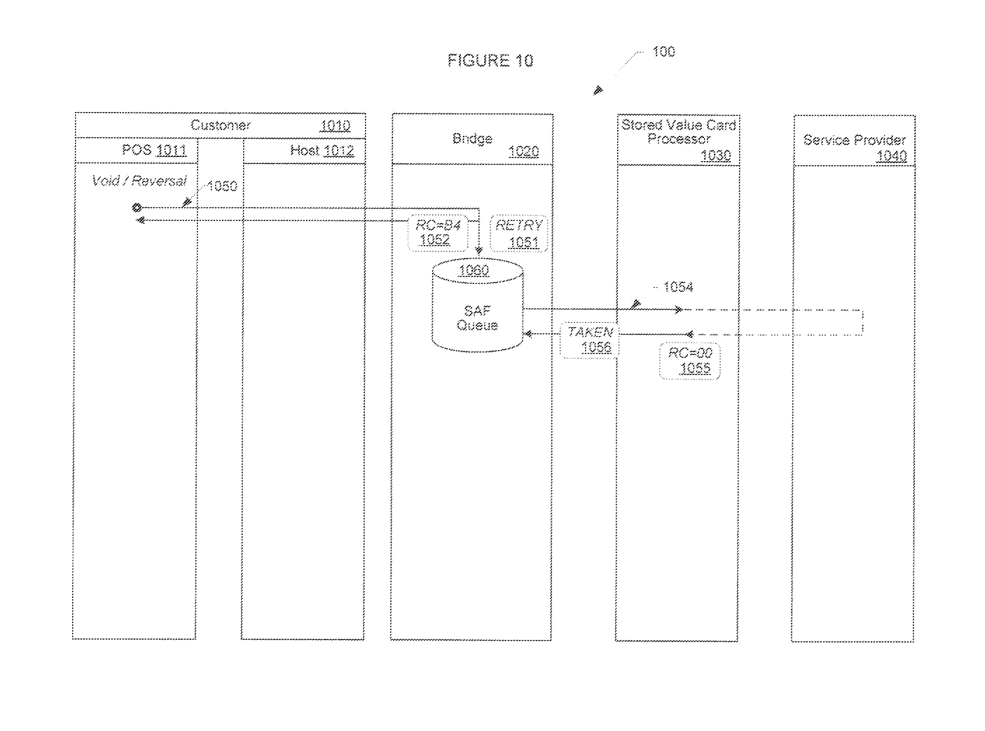

With reference to FIG. 10, a scenario 1000 involving originator-based voids and reversals is illustrated. In general, a bridge may receive a reversal-class (MTI 0400) message from the customer host. This transaction request may be based in (i) a cancellation/void at the POS; (ii) a system timeout at the POS; or (iii) a system timeout at the host. The bridge may accept such requests locally, and place the items into the SAF queue and respond with an RC of ‘B4’ (force approval/reversal accepted). Subsequently and potentially asynchronously, the bridge may send the SAF-ed request to the stored value card processor. If this retry succeeds, the item may be marked ‘TAKEN’ and removed from consideration for future SAF unloading actions.

With continued reference to FIG. 10, the example above is graphically illustrated. A transaction may originate at a customer 1010. A customer POS 1011 may send a transaction request 1050 through its host 1012 and to the bridge 1020. Unlike before, the bridge 1020 may not try to send the transaction to the stored value card processor 1030, but may flag the item ‘RETRY’ at 1051, and return RC of ‘B4’ at 1052. The POS 1011 may receive this response at 1053. The item will then be provided to the SAF queue 1060, and will be provided to the stored value card processor 1030 at 1054. If accepted by the stored value card processor 1030 the RC may be set to ‘00’ at 1055, and the item may be flagged as ‘TAKEN’ at 1056, thereby removing it from the SAF queue.

Note that there may be scenarios win which the current content of a SAF table may influence the transaction processing behavior of the bridge. For example, if the bridge had previously placed a card activation in the SAF queue—but has yet to successfully deliver the item—but now receives a deactivation request for the same card, it may be appropriate to place the new item (deactivation) directly into the SAF queue in proper chronological order. The following table illustrates how the bridge may make specific judgments based on pending item content in the SAF tables, where “A” is activation, “AR” is activation reversal, “D” is deactivation, and “DR” is deactivation reversal.

| | | Top | |
|---|---|---|---|
| | | SAF | |
| Case | Request | Entry | Response |
| 1 | A | A | D1 - Decline on pending SAF |
| 2 | A | AR | B2 - Stand in approval on pending complementary item in SAF |
| 3 | A | D | B2 - stand in approval on pending complementary item in SAF |
| 4 | A | DR | If the top 3 SAF entries are DR-D-A, then there is an “Open A” |
| | | | condition (the ‘D’ was reversed, leaving the ‘A’ standing), then: |
| | | | D1 - Decline on pending SAF. Else - B2, stand in approval on |
| | | | pending complementary item in SAF |
| 5 | D | A | B2 - stand in approval on pending complementary item in SAF |
| 6 | D | AR | B2 - stand in approval on pending complementary item in SAF |
| 7 | D | D | B5 - Duplicate approval |
| 8 | D | DR | B2 - stand in approval on pending complementary item in SAF |

In some cases the top SAF entries depicted above may imply previous items for a card have also been SAF-ed. For example, in case 3 above, the only way a deactivation ends up in the SAF queue is if the activation that preceded it was also placed in the SAF. So a full sequence for case 3 should be, at least, ‘A-D-A.’ In practice, this progression often arises when a card buyer—confronted with a receipt that says “card will be active within twenty-four (24) hours”—demands that the card be retried because they desire immediate use of the product. This may put a sales clerk at a POS in the position of needing to deactivate and reactivate a product. However, until the SAF items have been unloaded, the result presented to the purchaser may remain the same.

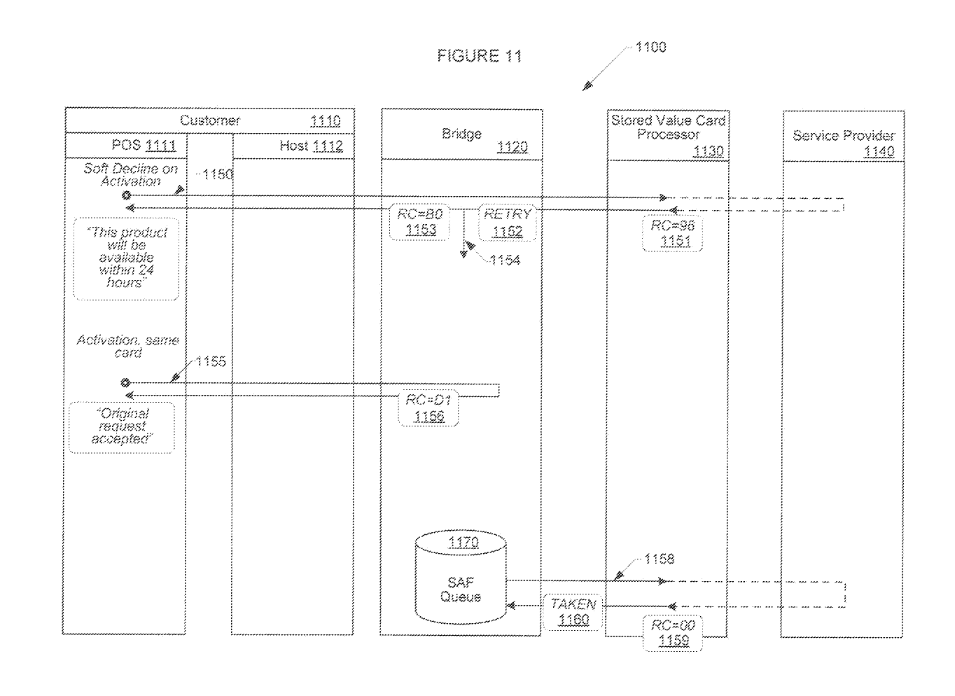

With reference to FIG. 11, an exemplary pending SAF situation 1100 will now be discussed. In general, this situation may arise when a transaction is soft declined by the stored value card processor, and the transaction is configured on the ‘retry-transaction-code’ list. The bridge may place the item into the SAF queue and change the RC code to 130 (stand in approval on decline). The bridge may inform the POS to inform the purchaser that “this product will be available for use within twenty-four (24) hours.” However, the bridge may then receive a second transaction for the same product. The bridge may check the SAF queue and determine that there is a pending item in the SAF queue. The bridge may therefore record a decline as ‘D1’, and report that back. Subsequently and asynchronously, the bridge may send the SAF-ed request of the item to the stored value card processor.

With continued reference to FIG. 11, the example above is graphically illustrated. A transaction may originate at a customer 1110. A customer POS 1111 may send a transaction request 1150 through its host 1112 and to the bridge 1120. As before, the bridge 1120 may try to send the transaction to the stored value card processor 1130. If the bridge 1120 receives a soft decline at 1151, it may flag the item as ‘RETRY’ at 1152, and return a RC code to the POS as B0 at 1153. At 1154 the bridge may send the item the SAF queue 1170 for later processing. If the bridge then receives a second transaction for the same card at 1155, the bridge may not pass this transaction to the stored value card processor 1130, but may issue an RC code of ‘D1’—or decline—at 1156. This may be provided to the POS 1111 at 1157, and may be informed “Original request accepted.” Subsequently, at 1158 the SAF queue 1170 may send the transaction request 1158 to the stored value card processor 1130, and receive an RC code of ‘00’ at 1159 indicating the transaction was accepted. At 1160 the item may be flagged as ‘TAKEN’ and removed from the SAF queue 1170.

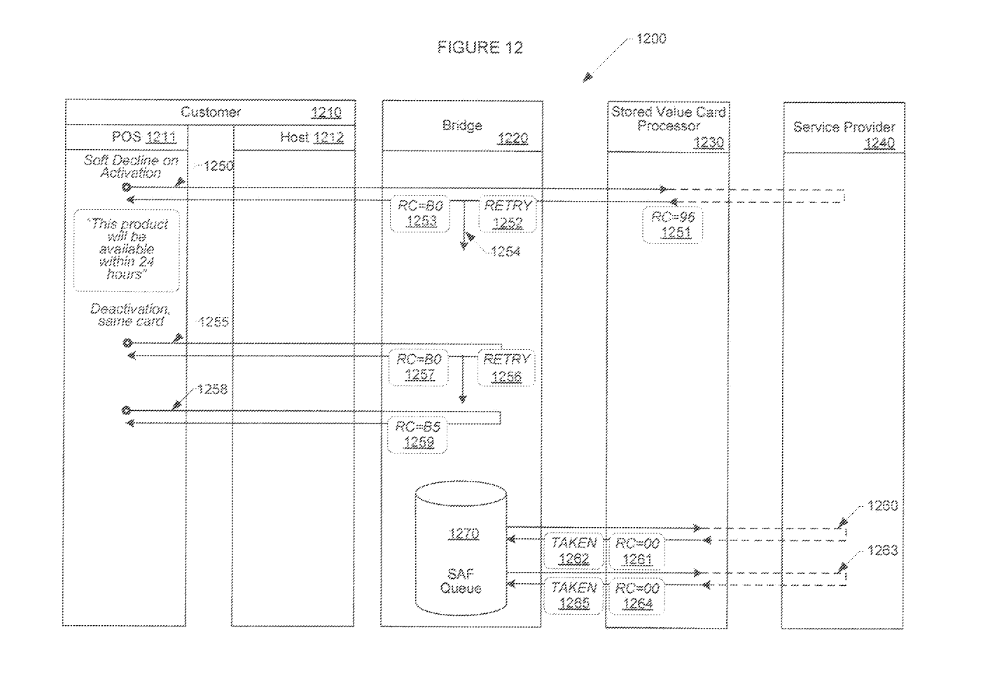

With reference to FIG. 12, some exemplary scenarios 1200 of complementary items in the SAF will now be discussed. In general, a transaction may be sent to a stored value card processor, may be soft-declined, and the transaction may be configured on the ‘retry-transaction-code’ list. The bridge may place the item into the SAF queue and change the RC reported back to the customer to ‘B0’ (stand-in approval on decline). The bridge may then receive a second transaction request for the same card, this time a deactivation. The bridge may check the SAF queue and recognize there is a pending activation. The bridge may the place the item into the SAF queue and report RC code of ‘B2’ (stand in approval on pending complementary item in SAF) back to the customer. The bridge may then receive another deactivation. Again, the bridge may check the SAF queue and determine there is a pending deactivation in the queue. Accordingly, the bridge may report back a RC code of ‘B5’ (duplicate approval). Subsequently and asynchronously, the bridge may send the SAF-ed requests of the two items (the activation and first deactivation) to the stored value card processor.

With continued reference to FIG. 12, the example above is graphically illustrated. A transaction may originate at a customer 1210. A customer POS 1211 may send a transaction request 1250 through its host 1212 and to the bridge 1220. As before, the bridge 1220 may try to send the transaction to the stored value card processor 1230. If the bridge 1220 receives a sot decline at 1251, it may flag the item as ‘RETRY’ at 1252, and return a RC code to the POS as B0 at 1253. At 1254 the bridge may send the item the SAF queue 1270 for later processing.

If the bridge then receives a second transaction for the same card at 1255, the bridge may not pass this transaction to the stored value card processor 1230, but may flag the item as ‘RETRY’ at 1256 and issue an RC code of ‘B2’ at 1257. The bridge 1220 may then receive a third transaction request for the same card at 1258. The bridge 1220 may again prevent this request from being sent to the stored value card processor 1230, and may instead return RC code ‘B5’ at 1259. Subsequently, at 1260 the SAF queue may send the first item at to the stored value card processor 1230, and may receive a RC code of ‘00’ at 1261, and may flag the first transaction item as ‘TAKEN’ at 1262. At 1263 the SAF queue may send the second transaction item to the stored value card processor 1230, which may again accept the transaction and return RC code of ‘00’ at 1264. At 1265 the second item may also be flagged as ‘TAKEN.’ Both items may be removed from the SAF queue.

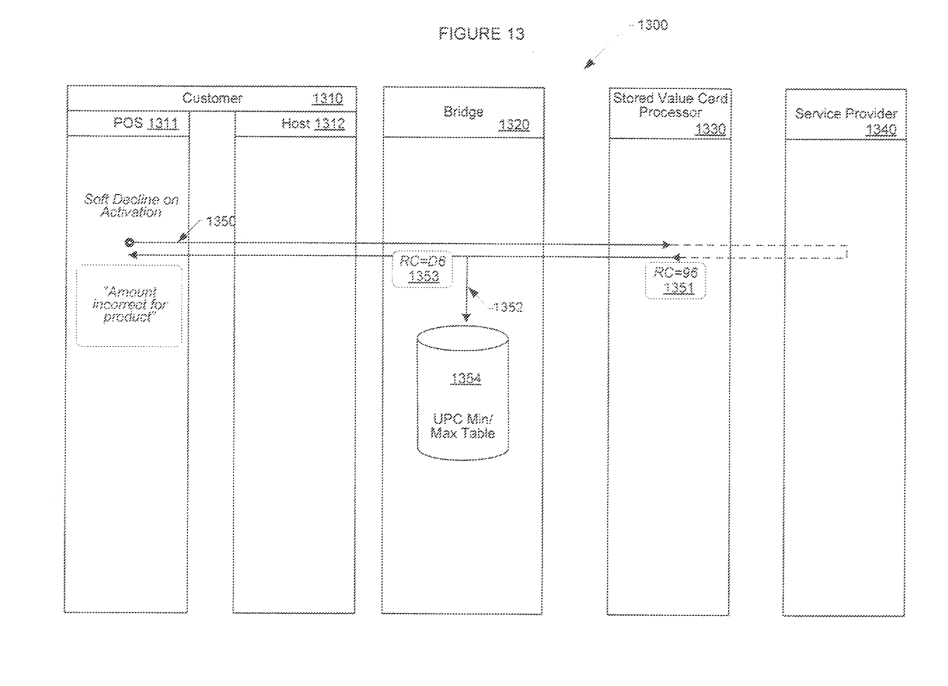

With reference to FIG. 13, an exemplary scenario 1300 of a UPC out of the accepted minimum—maximum range is illustrated. In general, a product may be attempted to be reloaded with an amount either below the minimum allowed, or over the maximum allowed. The transaction would be sent to the stored value card processor, which may issue a soft decline. The bridge may then check the configured minimum/maximum range for the UPC on the item file, and determine if the amount is less than or more than the limits. If the amount is less than the limits, the bridge may return RC code ‘D6’ (decline on UPC less than defined minimum amount), while if the amount is more than the maximum the bridge may return code ‘D7’ (decline on UPC more than defined maximum amount).

With continued reference to FIG. 13, the example above is graphically illustrated. A transaction may originate at a customer 1310. A customer POS 1311 may send a transaction request 1350 through its host 1312 and to the bridge 1320. The bridge 1320 may try to send the transaction to the stored value card processor 1330. If the bridge 1320 receives a soft decline at 1351, it may review the UPC maximum/minimum table 1354 at 1352, and return an RC code of ‘D6’ or ‘D7’ at 1353.

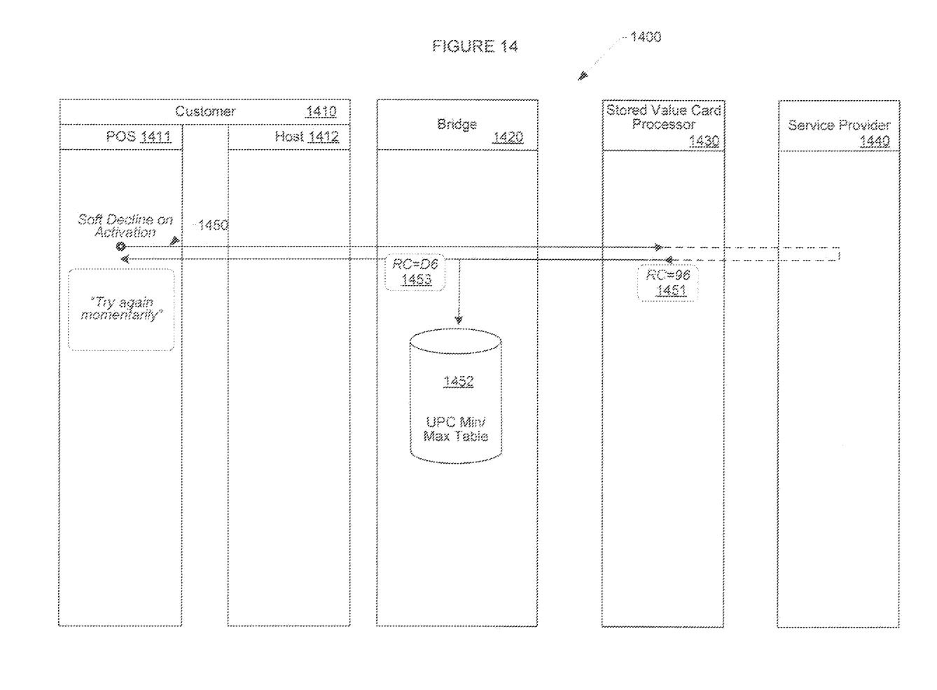

With reference to FIG. 14, an exemplary scenario 1400 of a UPC not active for SAF is illustrated. In general, a transaction may be soft declined by the stored value card processor, and the transaction may be configured on the ‘retry-transaction-code’ list. The bridge may check the configured minimum/maximum range for the item file on the UPC to determine if the value requested is in range. The bridge may also check the active flag on the item file for the UPC and determine that it is set to ‘N.’ Accordingly, the bridge may return RC of ‘D8’ (item not active for SAF; stand in approval on soft decline not taken).

With continued reference to FIG. 14, the example above is graphically illustrated. A transaction may originate at a customer 1410. A customer POS 1411 may send a transaction request 1450 through its host 1412 and to the bridge 1420. The bridge 1420 may try to send the transaction to the stored value card processor 1430. If the bridge 1420 receives a soft decline at 1451, it may review the UPC maximum/minimum table 1452, and return an RC code of ‘D8’.

### Logging

All bridge actions may be recorded into a log file, referred to informally as the ‘Q2’ log. Troubleshooting and event analysis may typically start by examining these files. Such files may also assist a reader in understanding how the bridge works. The logs may be governed by a log rotator service—where each log is kept at a manageable size (for example, no greater than 100 MB).

Entries in the logs may show a list of all application components deploying (during start up) and undeploying (during shutdown). The logs may be examined as part of a regular practice to validate a ‘clean’ start-up. This may be pertinent when in the process of adding new features and functions to the application.

For a ‘normal’ transaction, logging may result in four (4) entries: (i) inbound request (from the customer's host); (ii) outbound request (to the external authorizer); (iii) inbound response (from the external authorizer); and/or (iv) outbound response (back to the customer's host). In accordance with some embodiments, in order to save space and reduce processing overhead, only certain pertinent ISO8583 request and response fields (e.g., PC/3, STAN/11. RRN/37. RC/39) may be displayed in the logs

If a transaction is SAF-ed or if any subsequent action takes place in which SAF content is updated, such information may be relayed to the peer node so that the SAF content of both nodes remain in synch. In a ‘normal’ replication attempt, this logging may result in two entries: outbound request (to the peer node) and inbound response (from the peer node). The entry may represent the original replication request. i.e., when the item is first committed to SAF on the node that processed the request.

In addition, attempts to SAF to the external authorizer may also be logged. This may result in two entries: outbound request (to the external authorizer); and inbound response (from the external authorizer). In accordance with some embodiments, the original STAN may be replaced with a unique STAN. In addition, channel-level SAF-ed requests may be discerned (vs. real-time requests) via the ‘01’ denotation in POS Condition Code.

Each time a node completes its attempt to unload a SAF request, the corresponding peer node may be informed. Various replication request fields in exemplary coding may include items such as: (i) 39—Response Code (Field 39) as returned by the authorizer in the SAF response (gets recorded in peer's safMeta.lastRRC column); (ii) 105—Auth ID (Field 38) as returned by authorizer (gets recorded in peer's safMeta, lastAuthid colum); (iii) 121—Tranlog ID of the request (used by the peer—in conjunction with the node value in Field 123 (see below)—to locate the record in safMeta; on any node Pair, node+tranId are a unique identifier within safMeta); (iv) 122—Status of the request (gets recorded in peer's safMeta.status column); (v) 123—Node of the request (see 121 above for lookup role); (vi) 125—Updated attempt count related to the request (gets recorded in peer's safMeta.attempts column); (vii) 126—Time of the attempt (gets recorded in peer's safMeta.lastSent column); and/or (viii) 127—Last STAN of the attempt (gets recorded in peer's safMeta.lastStan column).

A main transaction manager (‘TM’) summary may also be maintained. For example, a summary of a real-time transaction information may be recorded. Such transaction information may include, but is not limited to: (i) outbound request (to the external authorizer); (ii) outbound response (back to the customer's host); (iii) profiler (time spent in each transaction participant); (iv) Remote Response Code (‘RRC’) received from the external authorizer; (v) events relating to SAF checking; and/or (vi) if SAF processing is invoked, the replication request posted to the peer.

A summary SAF attempts may be recorded and packaged, including: outbound request (to the external authorizer); inbound response (from the external authorizer); profiler (time spent in each transaction participant); replication request/response (to/from peer node); and replication status.

On the peer node, a record of all SAF activity generated on the originating node may also be logged. This may be accomplished by means of a ‘replication request.’ The Replication TM may handle replication requests emanating from possible creation points on the originating node, including but not limited to: (i) Main TM—may generate ‘original’ requests (to the peer) during real-time transaction processing for items that end up in SAF; (ii) SAF TM—may generate ‘update’ requests to the peer during subsequent SAF unloading: (iii) Sync TM—may generate ‘original’ or update’ peer requests when the originating node is synching the peer node (after an outage on—or lack of communication from—the peer); and/or (iv) Retry TM—may generate ‘original’ peer requests if the first request from the Main TM failed, or may generate ‘update’ peer requests if the SAF TM or Synch TIM ‘update’ peer request failed.

A request may be an ‘original’ (i.e., the full SAF entry) or an ‘update’ (i.e., a change in status or other information concerning an entry that the originating node knows the peer node has already recorded). The replication logic may discern an ‘original’ from an ‘update’ via ISO Field 3. If present, the request may be processed as an ‘original’; if absent, the request may be processed as an ‘update.’

For High Availability purposes, a State Controller may be used to help the two nodes stay in synch and understand what each other's respective role needs to be at any given point in operation. We record changes in state in the state controller logs.

Moreover, filtering may be applied through logs. The presence of the ‘##’ tag or marker may allow a reader to apply a filter to the log in order to summarize events related to SAF decision-making, SAF events and HA State Control.

### Supporting Functions

A bridge customer may elect to import an ‘item file,’ which may serve to modify stand-in approval rules. The file may be constructed in comma-separated value (‘CSV’) format as follows (one record per item):

| | Data | | |
|---|---|---|---|
| Field | Type | Length | Description/Usage |
| UPC | AN | Fixed, 12 | Product UPC - this value appears in ISO 8583 Field 53 of |
| | | | the Activation request. This field is required if UPC |
| | | | validation is enabled (a recommended practice). |
| Minimum | N | Variable, 8 | the minimum allowable activation amount for the product. |
| Amount | | | |
| Maximum | N | Variable, 8 | The maximum allowable activation amount from the |
| Amount | | | product. |
| SAF Flag | AN | Fixed, 1 | Whether or not the product is available for Stand-In |
| | | | Approval and SAF (‘Y’) or not (‘N’). |

A bridge customer may initiate Item File import processing by FTP-ing a full file. For example, a file may be provided into: Bridge/spool/item_file/request (a.k.a., the ‘request’ sub-directory). The naming convention of the file is left to the initiator, but generally must have the suffix ‘.esv’ or .txt’. Any file not having one of these suffixes may be ignored. Periodically—for example, every 60 seconds—the Bridge application may check for the presence of a new import file using a directory polling (‘DirPoll’) facility. When a properly named file is found, the bridge may move it from the ‘request’ sub-directory to the ‘run’ sub-directory for processing. During import processing, the bridge may use the Item File input to construct a database table equivalent for subsequent use by the bridge transaction processing engine.

Upon successful completion of the import, the bridge may produce a report summarizing its actions. These reports may be placed into the ‘response’ sub=directory. On receipt of any malformed input file or upon any event causing processing to run to less than normal completion, the bridge may move a copy of the input file to the ‘bad’ sub-directory. Otherwise, the bridge may move files run to proper completion to the ‘archive’ sub-directory.

The online transaction processing (‘OLTP’) engine of the bridge may use the resulting item file content in the following manner. First, the bridge may determine if a transaction is SAF-able for stand-in approval because one of the following conditions is true: (i) the node is currently in ‘Suspend Mode’; (ii) there are one or more undelivered, complementary items in SAF for the same card; (iii) the request timed-out and the PC is on the retry list; or (iv) the request received a soft decline (as per the ‘retry-re’ list) and the PC is on the ‘retry-pc’ list

Then, if one of the conditions specified in (a) is true, the bridge may check to see if the UPC of the transaction (ISO 8583 Field 54) is on the item table and—if so—whether or not it is designated as a SAF-able item. Based on item file the bridge may override a previous decision to SAF as follows:

| Previous Bridge Decision | | New Bridge Decision |
|---|---|---|
| (‘SAF’) | Condition | (‘SAF Override’) |
| B0 - | Not on Item | D8 - |
| STANDIN_APPROVAL_ON_DECLINE | File OR | APPLERR_ITEM_INACT_DECLINE |
| | On Item File | |
| | as SAF = N | |
| B1 - | Not on Item | D9 - |
| STANDIN_APPROVAL_ON_TIMEOUT | File OR | APPLERR_ITEM_INACT_TIMEOUT |
| | On Item File | |
| | as SAF = N | |
| B2 - | Not on Item | D8 - |
| STANDIN_APPROVAL_ON_IN_SAF | File OR | APPLERR_ITEM_INACT_DECLINE |
| | On Item File | |
| | as SAF = N | |
| B3 -STANDIN_APPROVAL_ON_SUSPEND | Not on Item | D8 - |
| | File OR | APPLERR_ITEM_INACT_DECLINE |
| | On Item File | |
| | as SAF = N | |
| Any of B0-B3 | On Item File | D6 - APPLERR_ITEM_LESS |
| | as SAF = Y | |
| | AND | |
| | Amount < | |
| | SAF Min | |
| | for Item | |
| Any of B0-B3 | On Item File | D7 - APPLERR_ITEM_MORE |
| | as SAF-Y | |
| | AND | |
| | Amount > | |
| | SAF Max for | |
| | Item | |

### Exception File Processing

The bridge may create an Exception file content to send to the stored value card processor. These files may be scheduled to be created and delivered multiple times per day. The bridge may place an item on the Exception File if one of the following conditions is gtrue of an item on the SAF file: (i) the item expired (safMeta.status—‘EXP’); (ii) the item reached its maximum number of attempts (safMeta.status—‘MAZ’); or (iii) the item was hard-declined by the authorizer (safMeta.status—‘TAKEN’ and lastRRC< >‘00’). The exception file may constructed in pipe-limited format, and in accordance with some embodiments, a header and trailer are required. An empty file is signified by a header and trailer with no detail records. However, note that it is contemplated that empty files may still be sent to the stored value card processor.

| | Data | | |
|---|---|---|---|
| Field | Type | Length | Description/Usage |
| Type | AN | Fixed, 6 | ‘RT0100’ |
| Creation | N | Fixed, 14 | YYYYMMDDHHMMSS |
| Date/Time | | | |

### Detail Record

| | Data | | |
|---|---|---|---|
| Field | Type | Length | Description/Usage |
| Type | AN | Fixed, 6 | ‘RT0200’ |
| Transaction | AN | Fixed, 17 | ISO 8583 Data Element (‘DE’) 13 & 12 - |
| Date/Time | | | in format like ‘2013061912:35:58’ |
| Store ID | AN | Variable, 15 | ISO 8583 DE 42 out of |
| | | | safData.secureData |
| Terminal ID | AN | Variable, 8 | ISO 8583 DE 41 out of |
| | | | safData.secureData |
| Card Number | N | Variable, 47 | ISO 8583 DE 2 out of |
| | | | safData.secureData |
| Sign | N | Fixed, 1 | ‘1’; Act/Reload/Rev of Deact; −1: |
| | | | Deact/Rev of Act/Rev. of Reload) where |
| | | | Act = 189090, Deact = 289090, Reload = |
| | | | 199090 - saMeta.pc + safData.reversal |
| Card Amount | N | Variable, 12 | ISO8583 DE4 out of safData.secureData |
| | | | or safData.amount |
| Discount Amount | N | Variable, 12 | Not used, left blank in file |
| Net Amount | N | Variable, 12 | Not used, left blank in file |
| UPC | AN | Fixed, 12 | ISO8583 DE54 out of |
| | | | safData.secureData |
| Currency | AN | Fixed, 3 | ISO8583 DE 49 out of |
| | | | safData.secureData |
| STAN | N | Fixed, 12 | System Trace Audit Number (‘STAN’, |
| | | | ISO8583 DE 11) provided by the bridge |
| | | | in the last SAF request (saved in |
| | | | safMeta.lastSTAN) |
| Trace ID | N | Fixed, 20 | An authorization code provided by the |
| | | | stored value card processor in the last |
| | | | SAF response (saved in |
| | | | safMeta.lastAuthId) |
| Activation Data | AN | Variable, 37 | ISO8583 DE 35 out of |
| | | | safData.secureData (if present - may be |
| | | | required to resolve certain products) |

### Trailer Record

| | Data | | |
|---|---|---|---|
| Field | Type | Length | Description/Usage |
| Type | AN | Fixed, 6 | ‘RT0300’ |
| End Specifier | AN | Fixed, 3 | ‘END’ |

Note that if the bridge creates an exception file, the file name may include a timestamp from the system at inception of the file creation, and may also reflect the ID of the exception job run in which the file was created.

The bridge may deliver the files using a secure FTP facility, which may be periodically operated. The bridge may make a recording on the saf.Meta table (in the extractId column) as to whether a SAF entry was included on an exception file, and if so, which one. The table below illustrates exemplary table entries and meanings.

| Value | Value | |
|---|---|---|
| Description | Example | Description/Usage |
| <1,000,000 | 566 | Item is an exception because its final status is either ‘EXP’, ‘MAX’, or |
| | | ‘TAKEN’ with safMeta.lastRRC <> ‘00’; |
| | | Item may be included in exception file because the extract job on the node |
| | | may be configured as <property name =“create-output-file” value=“true”/>; |
| | | or |
| | | Value recorded may be the current iteration of the extract. In this |
| | | example, it is the 566^{th} time an extract program has been executed. |
| >1,000,000 | 1000566 | Item is an exception because its final status is one of (i)-(iii) above. Item |
| | | was not included in exception file because the extract job on the node is |
| | | configured as <property name =“create-output-file” value=“false”/>. Value |
| | | recorded is the current iteration of the extract + 1,000,000 to denote that |
| | | no output file was created. |
| <−1,000,000 | −1000567 | Item is not an exception because its final status is ‘TAKEN’ with |
| | | safMeta.lasRRC = ‘00’ |
| | | Item was not included in an exception file because it is not an exception |
| 0 | 0 | Item has not yet been characterised because either (i) item is still actively |
| | | being processed (status, is ‘RETRY’ or ‘PEND’); or (ii) item has achieved a |
| | | final status but applicable extract has not yet executed. |

It will be understood that the specific embodiments of the present invention shown and described herein are exemplary only. Numerous variations, changes, substitutions and equivalents will now occur to those skilled in the art without departing from the spirit and scope of the invention. Accordingly, it is intended that all subject matter described herein and shown in the accompanying drawings be regarded as illustrative only, and not in a limiting sense.

What is claimed is:

1. An apparatus for locally processing stored value card transactions, the apparatus proximate to a retailer point-of-sale (POS) or host, the apparatus in selective communication with the POS or host and a stored value card processor, the apparatus comprising:
a POS or host interface enabling the selective communication with the POS or host;
a stored value card processor interface, enabling the selective communication with the stored value card processor; and
a processing module, enabling selective decision making for certain stored value card transaction requests.

2. The apparatus of claim 1, wherein during times of communication with the stored value card processor the processing module does not make decisions for certain stored value card transaction requests, but passes such requests through to the stored value card processor.

3. The apparatus of claim 1, during times of non-communication with the stored value card processor, the processing module locally makes decisions for certain stored value card transaction requests.

4. The apparatus of claim 3, wherein once communication between the processing module and the stored value card processor is reestablished, the processing module updates the stored value card processor with transactions conducted locally.

5. The apparatus of claim 1, wherein the during times of communication with the stored value card processor, the processing module locally overrides certain decisions of the stored value card processor, based upon a response received from the stored value card processor.

6. The apparatus of claim 5, wherein the stored value card processor only locally overrides certain decisions of the stored value card processor if the stored value card type or denomination, transaction type, and/or transaction amount are stored as eligible for override.

7. The apparatus of claim 6, wherein a certain decision overrode by the processing module is a soft decline.

8. The apparatus of claim 1, wherein the decisions comprise activations, deactivations, reloads, and/or refresh transactions.

9. The apparatus of claim 1, further comprising a store-and-forward module that, once communication between the processing module and the stored value card processor is reestablished, the updates the stored value card processor with transactions conducted locally.

10. The apparatus of claim 1, further comprising at least two (2) databases in communication with a content replication application to provide redundant storage.

11. The apparatus of claim 1, wherein the apparatus is in communication with the POS or host through one or more load balancers or a multiplexer.

12. A method of locally authorizing stored value card transactions, the method conducted amongst a retailer point-of-sale (POS) or host, a bridge processor, and a stored value card processor, the bridge processor being disposed locally with the POS or host, the method comprising:
receiving at the bridge processor a transaction request;
determining by the bridge processor if the transaction request should be passed through to the stored value card processor or decided upon locally;
upon a determination that the transaction request should be passed through to the stored value card processor;
communicating such request from the bridge to the stored value card processor;
upon receiving a certain response from stored value card processor, or from the attempted communication with the stored value card processor, locally overriding by the bridge processor the response of the stored value card processor or deciding upon the transaction request locally;
upon a determination that the transaction request should not be passed through to the stored value card processor;
locally deciding by the bridge processor the transaction request; and
communicating by the bridge a transaction request response back to the POS or host.

13. The method of claim 12, wherein the certain response from the stored value card processor is a soft decline or a host timeout.

14. The method of claim 12, wherein determining by the bridge processor if the transaction request should be passed through to the stored value card processor, or decided upon locally comprises:
determining the type of transaction requested from the POS or host;
determining if a processing code associated with the type of transaction and/or the stored value card is flagged as eligible for local processing; and/or
determining if the bridge is in communication with the stored value card processor.

15. The method of claim 14, wherein if the processing code associated with the type of transaction and/or the stored value card is not flagged as eligible for local processing, the bridge then acting as a pass-through, and passing the transaction request to the stored value card processor and the response to the transaction request back to the POS or host.

16. The method of claim 13, wherein if the bridge is not in communication with the stored value card processor, locally conducting at least some transactions at the bridge until communication with the stored value card processor is reestablished.

17. The method of claim 12, wherein the bridge locally processes transaction requests following a timeout received from the stored value card processor.

18. The method of claim 12, wherein the certain response received from the stored value card processor that is locally overridden by the bridge processor is a soft decline.

19. An apparatus for locally processing stored value card transactions, the apparatus proximate to a retailer point-of-sale (POS) or host, the apparatus in selective communication with the POS or host and a stored value card processor, the apparatus configured to:
receive a transaction request;
determine if the transaction request should be passed through to the stored value card processor, or decided upon locally;
upon a determination that the transaction request should be passed through to the stored value card processor;
communicate such request to the stored value card processor;
upon receiving a certain response from stored value card processor, or from the attempted communication with the stored value card processor, locally overriding the response of the stored value card processor or deciding upon the transaction request locally;
upon a determination that the transaction request should not be passed through to the stored value card processor;
locally deciding the transaction request;
communicating a transaction request response back to the POS or host; and
following a local override or local decision, storing information regarding the override or decision and forwarding such information to the stored value card processor once communication is reestablished.
